(19) United States
(12) Patent Application Publication
(10) Pub. No.: US 2026/0342735 A1
(43) Pub. Date: Oct. 29, 2026

(54) PROCESSING METHOD AND APPARATUS FOR PACKET LOSS, AND COMMUNICATION DEVICE AND STORAGE MEDIUM

(71) Applicant: Beijing Xiaomi Mobile Software Co., Ltd., Beijing (CN)

(72) Inventors: Jinhua WU, Beijing (CN); Jianning LIU, Beijing (CN); Yuxin MAO, Beijing (CN)

(73) Assignee: Beijing Xiaomi Mobile Software Co., Ltd., Beijing (CN)

(21) Appl. No.: 19/111,641

(22) PCT Filed: Sep. 16, 2022
(86) PCT No.: PCT/CN2022/119483

§ 371 Date: Mar. 13, 2025

(51) Int. Cl. H04L 47/32; H04L 47/24

(52) U.S. Cl. CPC H04L 47/32; H04L 47/24

(57) ABSTRACT

Provided in the embodiments of the present disclosure is a processing method for packet loss, wherein the method is executed by an access network node. The method comprises: sending indication information to a first network function, wherein the indication information is used for indicating at least one of the following: packet-loss event information for quality of service (QoS) flow processing based on a packet data unit (PDU) set; and packet-loss indication information for QoS flow processing based on the PDU set. In contrast to a mode in which indication information is not sent, a network can execute an operation for packet-loss on the basis of the indication information, such that when congestion occurs, the transmission efficiency of a service data flow is improved, and the QoS is improved, thus providing a good experience for users.

### CROSS REFERENCE TO RELATED APPLICATIONS

This application is a US National Phase of a PCT Application No. PCT/CN2022/119483 filed on Sep. 16, 2022, the entire contents of which are incorporated herein by reference in their entireties.

### TECHNICAL FIELD

The present disclosure relates to the field of wireless communication technology, but is not limited to the field of wireless communication technology, and particularly relates to packet discarding processing methods and apparatuses, communication devices, and storage media.

### BACKGROUND

With the development of wireless networks, wireless communication systems adopt Quality of Service (QoS) mechanisms. In an application scenario, service data flows have characteristics of high bandwidth, low latency, and high reliability requirements, which require matching the QoS requirements of data units and datasets in the data flows to enhance user experience. In related arts, when network congestion occurs, the QoS of the service cannot be met, which affects the user experience.

### SUMMARY

The embodiments of the present disclosure disclose packet discarding processing methods and apparatuses, communication devices, and storage media.

According to the first aspect of the embodiments of the present disclosure, a packet discarding processing method is provided, where the method is performed by an access network node, and the method includes:
transmitting indication information to a first network function. Where the indication information is configured to indicate at least one of the following: information of a Packet Data Unit (PDU) set based Quality of Service (QoS) handling packets discarding event; or information of a PDU set based QoS handling packets discarding indication.

According to the second aspect of the embodiments of the present disclosure, a packet discarding processing method is provided, where the method is performed by a first network function, and the method includes:
receiving indication information transmitted by an access network node. Where the indication information is configured to indicate at least one of the following: information of a PDU set based QoS handling packets discarding event; or information of a PDU set based QoS handling packets discarding indication.

According to the third aspect of the embodiments of the present disclosure, a packet discarding processing method is provided, where the method is performed by a second network function, and the method includes:
receiving notification information transmitted by a first network function. Where the notification information includes at least one of: information of a measured report; information of a packets discarding event, where the information of the packets discarding event indicates a triggering condition for conditional discarding; or information of a packets discarding indication, where the information of the packets discarding indication indicates whether conditional discarding is needed to be performed or whether conditional discarding is allowed to be performed.

According to the fourth aspect of the embodiments of the present disclosure, a packet discarding processing method is provided, where the method is performed by a third network function, and the method includes:
receiving notification information transmitted by UDR. Where the notification information includes at least one of: information of a measured report; information of a packets discarding event, where the information of the packets discarding event indicates a triggering condition for conditional discarding; or information of a packets discarding indication, where the information of the packets discarding indication indicates whether conditional discarding is needed to be performed or whether conditional discarding is allowed to be performed.

According to the fifth aspect of the embodiments of the present disclosure, a packet discarding processing method is provided, where the method is performed by a fourth network function, and the method includes: receiving authorization information transmitted by a third network function. Where the authorization information is configured to indicate performing of packet discarding on at least one of a data flow, a data unit set, or a data packet.

According to the sixth aspect of the embodiments of the present disclosure, a packet discarding processing apparatus is provided, and includes:
a transmitting module, configured to transmit indication information to a first network function. Where the indication information is configured to indicate at least one of the following: information of a Packet Data Unit (PDU) set based Quality of Service (QoS) handling packets discarding event; or information of a PDU set based QoS handling packets discarding indication.

According to the seventh aspect of the embodiments of the present disclosure, a packet discarding processing apparatus is provided, and includes:
a receiving module, configured to receive indication information transmitted by an access network node. Where the indication information is configured to indicate at least one of the following: information of a PDU set based QoS handling packets discarding event; or information of a PDU set based QoS handling packets discarding indication.

According to the eighth aspect of the embodiments of the present disclosure, a packet discarding processing apparatus is provided, and includes:
a receiving module, configured to receive notification information transmitted by a first network function, where the notification information includes at least one of: information of a measured report; information of a packets discarding event, where the information of the packets discarding event indicates a triggering condition for conditional discarding; or information of a packets discarding indication, where the information of the packets discarding indication indicates whether conditional discarding is needed to be performed or whether conditional discarding is allowed to be performed.

According to the ninth aspect of the embodiments of the present disclosure, a packet discarding processing apparatus is provided, and includes:
a receiving module, configured to receive notification information transmitted by UDR. Where the notification information includes at least one of: information of a measured report; information of a packets discarding event, where the information of the packets discarding event indicates a triggering condition for conditional discarding; or information of a packets discarding indication, where the information of the packets discarding indication indicates whether conditional discarding is needed to be performed or whether conditional discarding is allowed to be performed.

According to the tenth aspect of the embodiments of the present disclosure, a packet discarding processing apparatus is provided, and includes:
a receiving module, configured to receive authorization information transmitted by a third network function. Where the authorization information is configured to indicate performing of packet discarding on at least one of a data flow, a data unit set, or a data packet.

According to the eleventh aspect of the embodiments of the present disclosure, a packet discarding processing system is provided, including a first network function, a second network function, a third network function, and a fourth network function. The first network function is configured to perform any one of the methods in the present disclosure performed by the first network function, the second network function is configured to perform any one of the methods in the present disclosure performed by the second network function, the third network function is configured to perform any one of the methods in the present disclosure performed by the third network function, and the fourth network function is configured to perform any one of the methods in the present disclosure performed by the fourth network function.

According to the twelfth aspect of the embodiments of the present disclosure, a communication device is provided, and includes:
one or more processors; and one or more memories storing instructions executable by the one or more processors, and
where the one or more processors are configured to execute the executable instructions to implement the method according to any one of the embodiments of the present disclosure.

According to the thirteenth aspect of the present disclosure, a computer storage medium is provided, which stores a computer executable program, where when the executable program is performed by one or more processors, the method according to any one of the embodiments of the present disclosure is implemented.

In embodiments of the present disclosure, indication information is transmitted to the first network function; where the indication information is configured to indicate at least one of: information of a Packet Data Unit (PDU) set based Quality of Service (QoS) handling packets discarding event; or information of a PDU set based QoS handling packets discarding indication. Here, since the access network node transmits information of a Packet Data Unit (PDU) set based Quality of Service (QoS) handling packets discarding event and/or information of a PDU set based QoS handling packets discarding indication to the first network function, upon receiving the information of the packets discarding event and/or information of the packets discarding indication, the first network function can perform packets discarding processing based on the information of the packets discarding event and/or information of the packets discarding indication. Compared to a method where indication information is not transmitted, the network can perform packets discarding based on the indication information, which improves the transmission efficiency of service data flows, enhances QoS, and brings a good user experience when congestion occurs.

### BRIEF DESCRIPTION OF DRAWINGS

FIG. 1 is a schematic structural diagram of a wireless communication system according to an embodiment.

FIG. 2 is a flowchart of a packet discarding processing method according to an embodiment.

FIG. 3 is a flowchart of a packet discarding processing method according to an embodiment.

FIG. 4 is a flowchart of a packet discarding processing method according to an embodiment.

FIG. 5 is a flowchart of a packet discarding processing method according to an embodiment.

FIG. 6 is a flowchart of a packet discarding processing method according to an embodiment.

FIG. 7 is a flowchart of a packet discarding processing method according to an embodiment.

FIG. 8 is a flowchart of a packet discarding processing method according to an embodiment.

FIG. 9 is a flowchart of a packet discarding processing method according to an embodiment.

FIG. 10 is a flowchart of a packet discarding processing method according to an embodiment.

FIG. 11 is a flowchart of a packet discarding processing method according to an embodiment.

FIG. 12 is a flowchart of a packet discarding processing method according to an embodiment.

FIG. 13 is a flowchart of a packet discarding processing method according to an embodiment.

FIG. 14 is a flowchart of a packet discarding processing method according to an embodiment.

FIG. 15 is a flowchart of a packet discarding processing method according to an embodiment.

FIG. 16 is a flowchart of a packet discarding processing method according to an embodiment.

FIG. 17 is a flowchart of a packet discarding processing method according to an embodiment.

FIG. 18 is a flowchart of a packet discarding processing method according to an embodiment.

FIG. 19 is a flowchart of a packet discarding processing method according to an embodiment.

FIG. 20 is a flowchart of a packet discarding processing method according to an embodiment.

FIG. 21 is a schematic diagram of a packet discarding processing apparatus according to an embodiment.

FIG. 22 is a schematic diagram of a packet discarding processing apparatus according to an embodiment.

FIG. 23 is a schematic diagram of a packet discarding processing apparatus according to an embodiment.

FIG. 24 is a schematic diagram of a packet discarding processing apparatus according to an embodiment.

FIG. 25 is a schematic diagram of a packet discarding processing apparatus according to an embodiment.

FIG. 26 is a schematic diagram of a packet discarding processing system according to an embodiment.

FIG. 27 is a schematic structural diagram of a terminal according to an embodiment.

FIG. 28 is a block diagram of a base station according to an embodiment.

FIG. 29 is a schematic diagram of a network architecture according to an embodiment.

### DETAILED DESCRIPTION

Embodiments will be described in detail here with the examples thereof expressed in the drawings. When the following descriptions involve the drawings, like numerals in different drawings represent like or similar elements unless stated otherwise. The embodiments described in the following examples do not represent all embodiments consistent with the present disclosure. Instead, they are merely examples of methods, apparatuses and devices consistent with certain aspects of the disclosure, as detailed in the appended claims.

The term used in the embodiments of the present disclosure is for the purpose of describing particular examples only and is not intended to limit the embodiments of the present disclosure. As used in embodiments of the present disclosure and the appended claims, the singular forms “a”, “an” and “the” are intended to include the plural forms as well, unless the context clearly indicates otherwise. It should further be understood that the term “and/or” as used herein refers to and includes any and all possible combinations of one or more of the associated listed items.

It shall be understood that, although the terms “first,” “second,” “third,” and the like may be used herein to describe various information, the information should not be limited by these terms. These terms are only used to distinguish the same type of information from each other. For example, without departing from the scope of the present disclosure, first information may be referred as second information; and similarly, second information may also be referred as first information. Depending on the context, the word “if” as used herein can be interpreted as “at the time of”, “when” or “in response to determining”.

For the purpose of simplicity and ease of understanding, the terms used in the present disclosure to represent comparison are “greater than”, “less than”. But for those skilled in the art, it can be understood that the term “greater than” also encompasses the meaning of “greater than or equal to”, “less than” also encompasses the meaning of “less than or equal to”.

Referring to FIG. 1, a schematic structural diagram of a wireless communication system according to an embodiment is illustrated. As shown in FIG. 1, the wireless communication system is a communication system based on mobile communication technology, where the wireless communication system can include several user devices 110 and several access network nodes. It should be noted that the access network nodes can be base stations 120. The user device 110 can be a terminal. The terminal referred to in the present disclosure may include but are not limited to a mobile phone, a wearable device, an in-vehicle terminal, a Road Side Units (RSU), a smart home terminal, an industrial sensing device, and/or a medical device. In some embodiments, the terminal may be a Redcap terminal or a predetermined version of a new ratio (NR) terminal (e.g., an R17 NR terminal).

Where user devices 110 may be devices providing voice and/or data connectivity to users. The user device 110 can communicate with one or more core networks via a Radio Access Network (RAN). The user device 110 can be an IoT (Internet of Things) user device, such as a sensor device, a mobile phone, or a computer with an IoT user device. For example, the user device 110 can be a fixed, portable, pocket-sized, handheld, computer-built-in, or vehicle-mounted device, such as a station (STA), a subscriber unit, a subscriber station, a mobile station, a mobile, a remote station, an access point, a remote terminal, an access terminal, a user terminal, a user agent, a user device, or a user equipment. Or, the user device 110 may also be an unmanned aerial vehicle device. Or, the user device 110 can also be a vehicle-mounted device, such as a trip computer with a wireless communication capability, or a wireless user device with a trip computer externally connected. Or, the user device 110 can be an infrastructure, such as a street light, a signal light or other infrastructures with wireless communication capabilities and the like.

The base stations 120 may be network side devices in the wireless communication system. The wireless communication system may be a 4th generation mobile communication (4G) system, also referred to as a Long Term Evolution (LTE) system, or the wireless communication system may be a 5G system, also referred to as a New Radio (NR) system or 5G NR system. Or, the wireless communication system can also be the next-generation system to the 5G system or other future wireless communication systems. One of the access networks in the 5G system can be referred to as the NG RAN (New Generation Radio Access Network).

The base stations 120 can be evolved base stations (eNBs) as adopted in 4G systems. Or, the base stations 120 can also be base stations (gNBs) in a 5G system with a centralized and distributed architecture. When the base stations 120 adopt the centralized and distributed architecture, a central unit (CU) and at least two distributed units (DU) are usually included. A Packet Data Convergence Protocol (PDCP) layer, a Radio Link Control (RLC) layer, and a Media Access Control (MAC) layer protocol stack are provided in the central unit; a Physical (PHY) layer protocol stack is provided in the distributed unit, and embodiments of the present disclosure do not limit the specific implementation of the base stations 120.

The base station 120 and the user device 110 can be connected to each other via a wireless air interface. In different implementations, the wireless air interfaces may be wireless air interfaces based on the fourth generation mobile communication network technology (4G) standard; or, the wireless air interfaces may be wireless air interfaces based on the fifth generation mobile communication network technology (5G) standard, for example, the wireless air interfaces may be New Radios; or, the wireless air interfaces may also be wireless air interfaces based on the next generation mobile communication network technology standard to the 5G or other future wireless communication technology standards.

In some embodiments, an E2E (End to End) connection may also be established between the user devices 110. For example, in vehicle to everything (V2X) communication scenarios, such as V2V (vehicle to vehicle) communication, V2I (vehicle to infrastructure) communication, V2P (vehicle to pedestrian) communication and the like.

Here, the above-mentioned user device can be considered as the terminal device in the following embodiments.

In some embodiments, the wireless communication system may also include a core network device 130.

Several base stations 120 each are connected to the core network device 130. The core network device 130 can be a core network device in a wireless communication system. Here, the core network device can correspond to network functions, such as Access and Mobility Management Function (AMF), User Plane Function (UPF), Session Management Function (SMF), and other communication nodes. The embodiments of the present disclosure do not limit the form in which the core network device 130 can be implemented.

In order to facilitate the understanding of those skilled in the art, multiple implementation methods are provided in the embodiments of the present disclosure to clearly illustrate the technical solutions of the present disclosure. Those skilled in the art can understand that each of the multiple implementation methods provided in the embodiments of the present disclosure can be executed separately, can be combined with the methods of other embodiments in the present disclosure, can be executed in combination with some methods in other related technologies, or can be executed in combination with the methods of other embodiments in the present disclosure and some methods in other related technologies, which is not limited in the embodiments of the present disclosure.

The application scenarios involved in the present disclosure are described.

Extended Reality and Media (XRM) services include mobile media services, Augmented Reality (AR), and/or Virtual Reality (VR), etc. XMR services, cloud gaming, and video-based machine and/or drone remote controlling services are expected to contribute increasingly high traffic (e.g., traffic of audio and video flows) to wireless communication networks.

The XR service includes multimodal data flows. For example, in addition to the audio and video flows mentioned herein, there are also data flows related to biological tactile perception. These multimodal data describe data input from the same device or different devices (including sensors) for the same service or application, and these data may be output to one or more destination device terminals. The various data flows in multimodal data often have correlations, such as synchronization of audio flows and video flows, synchronization of touch and vision, etc. The data flows of this type of media service themselves, various data flows, and the network transmission requirements of these service data flows all have some service characteristics. Effectively identifying and utilizing these service characteristics is helpful for the transmission and control of networks and services, as well as for service security and user experience.

However, when a universal QoS mechanism is adopted in a wireless communication network to handle various data services, including XR services, the service characteristics of XR services are not taken into account, which cannot effectively support the differentiated uplink and downlink requirements of these services, e.g., asymmetric requirements of high reliability for uplink data and high bandwidth for downlink data. At the same time, data flows including XR services have the characteristics of high bandwidth, low latency, and high reliability requirements, which requires further matching the QoS requirements of data units and data unit sets in the data flows. For example, the QoS requirements need to match the dependency relationships between data units in the data unit set, the dependency relationships between data unit sets, the importance (priority) of data units in the data unit set, and the importance (priority) of datasets), in order to effectively enhance the user experience.

At the same time, the characteristics of Extended Reality and Media (XRM) services with high bandwidth and low latency requirements pose new challenges to the data transfer and transmission via radio access network air interfaces. In the 5G system, it is researched how to optimize the data transfer of radio access network air interfaces based on information such as the dependency relationships and importance priorities between data units in the data unit set. However, when network congestion occurs, the transfer mechanism for data flows still cannot quickly alleviate the congestion. During the congestion process, data units exceeding the QoS latency threshold are discarded, which directly leads to the inability to meet the QoS for the service and a decrease in Quality of Experience (QoE). In related arts, 5G systems do not yet support data flows for the XR service, especially network side transfer enhancements for downlink data flows.

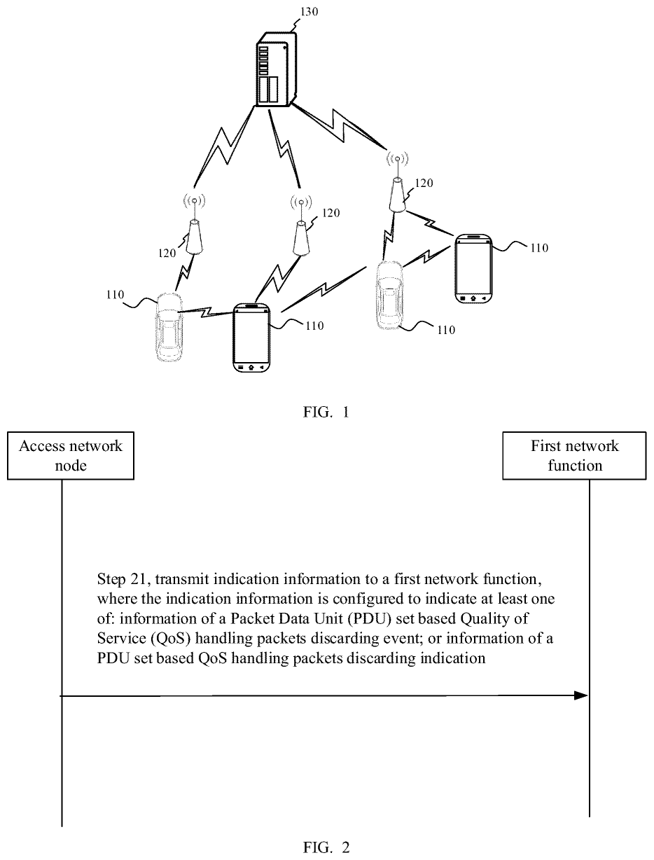

As shown in FIG. 2, this embodiment provides a packet discarding processing method, where the method is performed by an access network node, and the method includes step 21.

In step 21, indication information is transmitted to a first network function.

Where the indication information is configured to indicate at least one of: information of a Packet Data Unit (PDU) set based Quality of Service (QoS) handling packets discarding event; or information of a PDU set based QoS handling packets discarding indication.

The access network node referred to in the present disclosure may be a base station. The base station can be various types of base stations, such as a base station for third-generation mobile communication (3G) networks, a base station for fourth generation mobile communication (4G) networks, a base station for fifth generation mobile communication (5G) networks, or other evolved base stations. In an embodiment, the access network node referred to in the present disclosure may include the base station 120 described in FIG. 1.

The network functions referred to in the present disclosure can be devices in the core network, such as the core network devices in FIG. 1. For example, the first network function is a User Plane Function (UPF); the second network function is a Network Exposure Function (NEF); the third network function is a Policy Control Function (PCF); and the fourth network function is a Session Management Function (SMF). The network function can also be other evolved network functions, which is not limited here.

In an embodiment, indication information for a predetermined service is transmitted to the first network function; where the indication information is configured to indicate at least one of: information of a Packet Data Unit (PDU) set based Quality of Service (QoS) handling packets discarding event; or information of a PDU set based QoS handling packets discarding indication. In an embodiment, the predetermined service includes an Extended Reality and Media (XRM) service or a multimodal service. Here, multimodal services can refer to services that require obtaining information of multiple modalities, such as text, images, videos, and/or audio.

In an embodiment, indication information is transmitted to the first network function; where the indication information is configured to indicate at least one of: information of a Packet Data Unit (PDU) set based Quality of Service (QoS) handling packets discarding event; or information of or a PDU set based QoS handling packets discarding indication. Where the information of a Packet Data Unit (PDU) set based Quality of Service (QoS) handling packets discarding event is configured to indicate a triggering condition for conditional discarding. Where the information of the PDU set based QoS handling packets discarding indication is configured to indicate whether conditional discarding is needed to be performed or whether conditional discarding is allowed to be performed.

In an embodiment, indication information for downlink data flows of a predetermined service is transmitted to the first network function; where the indication information is configured to indicate at least one of: information of a Packet Data Unit (PDU) set based Quality of Service (QoS) handling packets discarding event; or information of a PDU set based QoS handling packets discarding indication. Where the information of the downlink packets discarding event is configured to indicate a triggering condition for conditional discarding; and/or Where the information of the PDU set based QoS handling packets discarding indication is configured to indicate whether conditional discarding is needed to be performed or whether conditional discarding is allowed to be performed.

In an embodiment, the information of the packets discarding indication is configured to indicate whether to perform conditional discarding or non-conditional discarding.

In an embodiment, the triggering condition includes at least one of the following: a degree of network congestion being greater than a degree threshold; a packet error rate being greater than a packet error rate threshold; a packet delay budget (PDB) being greater than a packet delay budget threshold; a terminal status being in a predetermined status; where the predetermined status may be a status related to overheating, battery, power mode, and GPU (graphics processing unit) load balancing; matching a packet discarding filter for data flows; matching a packet discarding filter for data packet sets; or matching a packet discarding filter for data packets.

In an embodiment, user plane function transmits indication information to the first network function; where the indication information is configured to indicate at least one of: information of a Packet Data Unit (PDU) set based Quality of Service (QoS) handling packets discarding event; or information of or a PDU set based QoS handling packets discarding indication.

In an embodiment, in procedure of the PDU set based QoS handling, indication information for packets discarding is transmitted to the first network function; where the indication information is configured to indicate at least one of: information of a Packet Data Unit (PDU) set based Quality of Service (QoS) handling packets discarding event; or information of or a PDU set based QoS handling packets discarding indication.

In an embodiment, in procedure of the PDU set based QoS handling, when a packet loss event (such as a network congestion event) occurs, indication information for packets discarding is transmitted to the first network function; where the indication information is configured to indicate at least one of: information of a Packet Data Unit (PDU) set based Quality of Service (QoS) handling packets discarding event; or information of or a PDU set based QoS handling packets discarding indication. Where the information of the packets discarding indication is carried in a header of an uplink data packet.

In an embodiment, in response to the absence of uplink data packets, the wireless network node creates uplink dummy data packets. In procedure of the PDU set based QoS handling, when a packet loss event (such as a network congestion event) occurs, indication information for packets discarding is transmitted to the first network function; where the indication information is configured to indicate at least one of: information of a Packet Data Unit (PDU) set based Quality of Service (QoS) handling packets discarding event; or information of or a PDU set based QoS handling packets discarding indication. Where the information of the indication is carried in a created uplink dummy data packet.

In embodiments of the present disclosure, indication information is transmitted to the first network function; where the indication information is configured to indicate at least one of: information of a Packet Data Unit (PDU) set based Quality of Service (QoS) handling packets discarding event; or information of a PDU set based QoS handling packets discarding indication. Here, since the access network node transmits information of a Packet Data Unit (PDU) set based Quality of Service (QoS) handling packets discarding event and/or information of a PDU set based QoS handling packets discarding indication to the first network function, upon receiving the information of the packets discarding event and/or information of the packets discarding indication, the first network function can perform packets discarding processing based on the information of the packets discarding event and/or information of the packets discarding indication. Compared to a method where indication information is not transmitted, the network can perform packets discarding based on the indication information, which improves the transmission efficiency of service data flows, enhances QoS, and brings a good user experience when congestion occurs.

It should be noted that those skilled in the art can understand that the methods provided in embodiments of the present disclosure can be executed separately or together with some methods in embodiments of the present disclosure or related arts.

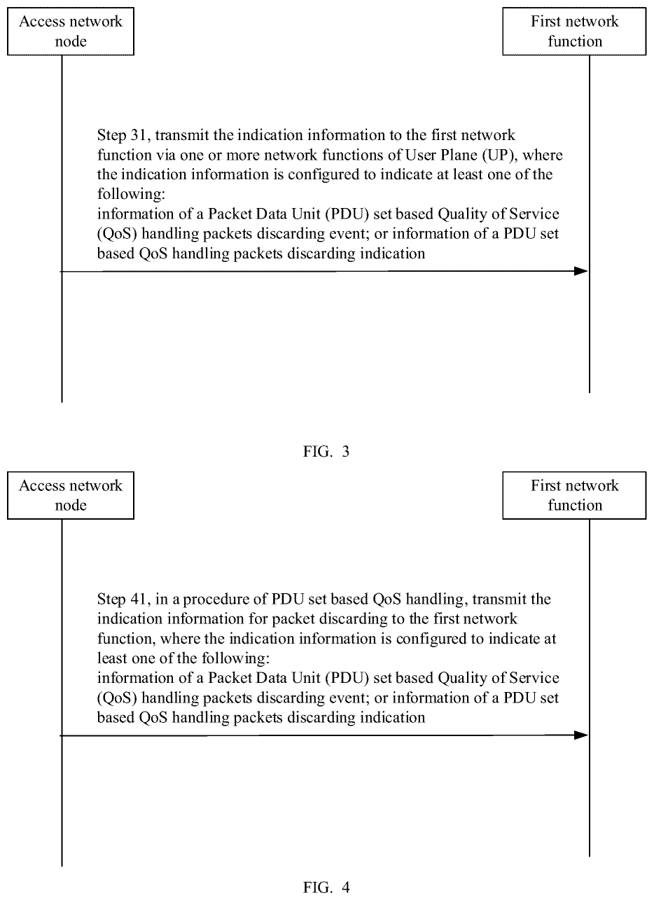

As shown in FIG. 3, this embodiment provides a packet discarding processing method, where the method is performed by an access network node, and the method includes step 31.

In Step 31, the indication information is transmitted to the first network function via one or more network functions of User Plane (UP).

Where the indication information is configured to indicate at least one of the following: information of a Packet Data Unit (PDU) set based Quality of Service (QoS) handling packets discarding event; or information of a PDU set based QoS handling packets discarding indication.

In an embodiment, indication information for downlink data flows of a predetermined service is transmitted to the first network function via one or more network functions of User Plane (UP); where the indication information is configured to indicate at least one of: information of a Packet Data Unit (PDU) set based Quality of Service (QoS) handling packets discarding event; or information of a PDU set based QoS handling packets discarding indication. The information of the packets discarding event is configured to indicate the triggering conditions for conditional discarding of data packets; and/or, the information of the PDU set based QoS handling packets discarding indication is configured to indicate whether conditional discarding for data packets needs to be performed; or whether conditional discarding for data packets is allowed to be performed.

In an embodiment, the information of the packets discarding indication is configured to indicate whether to perform conditional discarding or non-conditional discarding.

In an embodiment, the triggering condition includes at least one of the following: a degree of network congestion being greater than a degree threshold; a packet error rate being greater than a packet error rate threshold; a packet delay budget being greater than a packet delay budget threshold; a terminal status being in a predetermined status; where the predetermined status may be a status related to overheating, battery, power mode, and GPU (graphics processing unit) load balancing; matching a packet discarding filter for data flows; matching a packet discarding filter for data packet sets; or matching a packet discarding filter for data packets.

In this way, the indication information can be transmitted to the first network function via one or more network functions of User Plane (UP), achieving packet discarding based on the user plane.

It should be noted that those skilled in the art can understand that the methods provided in embodiments of the present disclosure can be executed separately or together with some methods in embodiments of the present disclosure or related arts.

As shown in FIG. 4, this embodiment provides a packet discarding processing method, where the method is performed by an access network node, and the method includes step 41.

In step 41, in a procedure of PDU set based QoS handling, the indication information for packet discarding is transmitted to the first network function.

Where the indication information is configured to indicate at least one of the following: information of a Packet Data Unit (PDU) set based Quality of Service (QoS) handling packets discarding event; or information of a PDU set based QoS handling packets discarding indication.

In an embodiment, in procedure of the PDU set based QoS handling, when a packet loss event (such as a network congestion event) occurs, indication information for packets discarding is transmitted to the first network function; where the indication information is configured to indicate at least one of: information of a Packet Data Unit (PDU) set based Quality of Service (QoS) handling packets discarding event; or information of or a PDU set based QoS handling packets discarding indication. Where the information of the packets discarding indication is carried in a header of an uplink data packet.

In an embodiment, in response to the absence of uplink data packets, the wireless network node creates uplink dummy data packets. In procedure of the PDU set based QoS handling, when a packet loss event (such as a network congestion event) occurs, indication information for packets discarding is transmitted to the first network function; where the indication information is configured to indicate at least one of: information of a Packet Data Unit (PDU) set based Quality of Service (QoS) handling packets discarding event; or information of or a PDU set based QoS handling packets discarding indication. Where the information of the indication is carried in a created uplink dummy data packet.

In this way, packet discarding processing can be implemented based on the procedure of the existing PDU set based QoS handling.

It should be noted that those skilled in the art can understand that the methods provided in embodiments of the present disclosure can be executed separately or together with some methods in embodiments of the present disclosure or related arts.

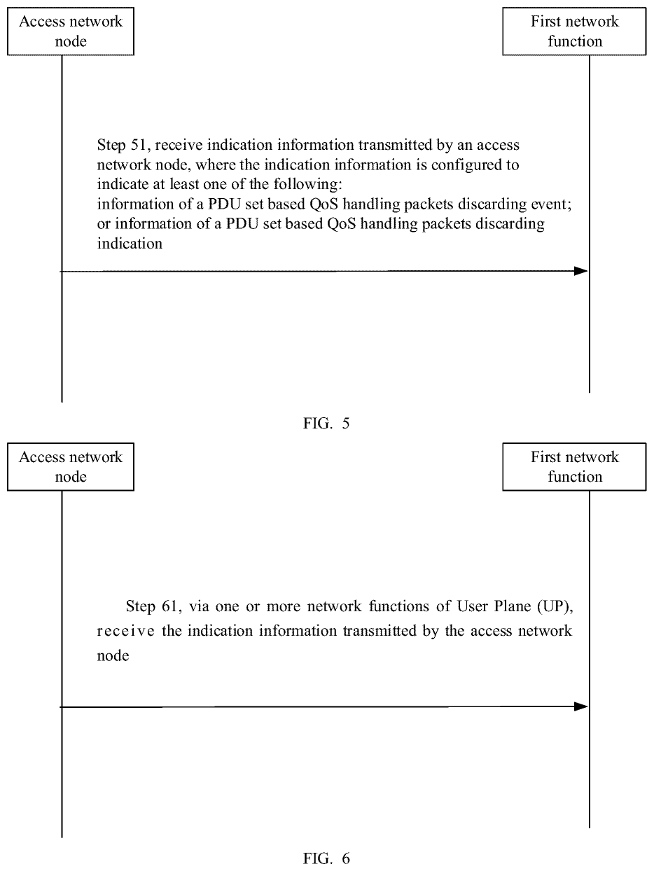

As shown in FIG. 5, this embodiment provides a packet discarding processing method, where the method is performed by a first network function, and the method includes step 51.

In step 51, indication information transmitted by an access network node is received.

Where the indication information is configured to indicate at least one of the following: information of a PDU set based QoS handling packets discarding event; or information of a PDU set based QoS handling packets discarding indication.

The terminal referred to in the present disclosure may include but are not limited to a mobile phone, a wearable device, an in-vehicle terminal, a Road Side Units (RSU), a smart home terminal, an industrial sensing device, and/or a medical device. In some embodiments, the terminal may be a Redcap terminal or a predetermined version of a new ratio (NR) terminal (e.g., an R17 NR terminal).

The access network node referred to in the present disclosure may be a base station. The base station can be various types of base stations, such as a base station for third-generation mobile communication (3G) networks, a base station for fourth generation mobile communication (4G) networks, a base station for fifth generation mobile communication (5G) networks, or other evolved base stations.

The network functions referred to in the present disclosure can be devices in the core network. For example, the first network function is a User Plane Function (UPF); the second network function is a Network Exposure Function (NEF); the third network function is a Policy Control Function (PCF); and the fourth network function is a Session Management Function (SMF). The network function can also be other evolved network functions, which is not limited here.

In an embodiment, indication information for a predetermined service transmitted by the access network node is received; where the indication information is configured to indicate at least one of: information of a Packet Data Unit (PDU) set based Quality of Service (QoS) handling packets discarding event; or information of a PDU set based QoS handling packets discarding indication. In an embodiment, the predetermined service includes an Extended Reality and Media (XRM) service or a multimodal service.

In an embodiment, indication information transmitted by the access network node is received; where the indication information is configured to indicate at least one of: information of a Packet Data Unit (PDU) set based Quality of Service (QoS) handling packets discarding event; or information of a PDU set based QoS handling packets discarding indication. The information of a PDU set based QoS handling packets discarding event is configured to indicate the triggering conditions for conditional discarding of data packets; and/or, the information of the PDU set based QoS handling packets discarding indication is configured to indicate whether conditional discarding for data packets needs to be performed; or whether conditional discarding for data packets is allowed to be performed.

In an embodiment, indication information for downlink data flows of a predetermined service transmitted by the access network node is received; where the indication information is configured to indicate at least one of: information of a Packet Data Unit (PDU) set based Quality of Service (QoS) handling packets discarding event; or information of a PDU set based QoS handling packets discarding indication. The information of the packets discarding event is configured to indicate the triggering conditions for conditional discarding of data packets; and/or, the information of the packets discarding indication is configured to indicate whether conditional discarding for data packets needs to be performed; or whether conditional discarding for data packets is allowed to be performed.

In an embodiment, the information of the packets discarding indication is configured to indicate whether to perform conditional discarding or non-conditional discarding.

In an embodiment, the triggering condition includes at least one of the following: a degree of network congestion being greater than a degree threshold; a packet error rate being greater than a packet error rate threshold; a packet delay budget being greater than a packet delay budget threshold; a terminal status being in a predetermined status; where the predetermined status may be a status related to overheating, battery, power mode, and GPU (graphics processing unit) load balancing; matching a packet discarding filter for data flows; matching a packet discarding filter for data packet sets; or matching a packet discarding filter for data packets.

In an embodiment, indication information transmitted by the access network node is received via one or more network functions of user plane; where the indication information is configured to indicate at least one of: information of a Packet Data Unit (PDU) set based Quality of Service (QoS) handling packets discarding event; or information of a PDU set based QoS handling packets discarding indication.

In an embodiment, in procedure of the PDU set based QoS handling, indication information for packets discarding transmitted by the access network node is received; where the indication information is configured to indicate at least one of: information of a Packet Data Unit (PDU) set based Quality of Service (QoS) handling packets discarding event; or information of or a PDU set based QoS handling packets discarding indication.

In an embodiment, in procedure of the PDU set based QoS handling, when a packet loss event (such as a network congestion event) occurs, indication information for packets discarding transmitted by the access network node is received; where the indication information is configured to indicate at least one of: information of a Packet Data Unit (PDU) set based Quality of Service (QoS) handling packets discarding event; or information of or a PDU set based QoS handling packets discarding indication. Where the information of the packets discarding indication is carried in a header of an uplink data packet.

In an embodiment, in procedure of the PDU set based QoS handling, when a packet loss event (such as a network congestion event) occurs, indication information for packets discarding transmitted by the access network node is received; where the indication information is configured to indicate at least one of: information of a Packet Data Unit (PDU) set based Quality of Service (QoS) handling packets discarding event; or information of or a PDU set based QoS handling packets discarding indication. Where the information of the indication is carried in a created uplink dummy data packet.

In an embodiment, indication information for a predetermined service transmitted by the access network node is received; where the indication information is configured to indicate at least one of: information of a Packet Data Unit (PDU) set based Quality of Service (QoS) handling packets discarding event; or information of a PDU set based QoS handling packets discarding indication. The indication information is transmitted to the third network function or the fourth network function; and the policy information determined by the third network function or the fourth network function based on the indication information is received, where the policy information is configured for performing packet discarding.

In an embodiment, indication information for a predetermined service transmitted by the access network node is received; where the indication information is configured to indicate at least one of: information of a Packet Data Unit (PDU) set based Quality of Service (QoS) handling packets discarding event; or information of a PDU set based QoS handling packets discarding indication. Notification information is transmitted to the second network function; where the notification information includes at least one of the following: information of a measured report; information of a packets discarding event; or information of the packets discarding indication.

In an embodiment, indication information for a predetermined service transmitted by the access network node is received; where the indication information is configured to indicate at least one of: information of a Packet Data Unit (PDU) set based Quality of Service (QoS) handling packets discarding event; or information of a PDU set based QoS handling packets discarding indication. When an application function (AF) subscribes notification information, the notification information is transmitted to the AF via a second network function; where the notification information includes at least one of the following: information of a measured report; information of a packets discarding event; or information of the packets discarding indication.

In an embodiment, indication information for a predetermined service transmitted by the access network node is received; where the indication information is configured to indicate at least one of: information of a Packet Data Unit (PDU) set based Quality of Service (QoS) handling packets discarding event; or information of a PDU set based QoS handling packets discarding indication. Configuration information transmitted by a fourth network function is received, where the configuration information indicates that the first network function performs packet discarding on data flows, data unit sets, or data packets.

In an embodiment, configuration information transmitted by a fourth network function is received, where the configuration information indicates that the first network function performs packet discarding on data flows, data unit sets, or data packets. The packet discarding is performed based on PDU set parameters and packet discarding policy information.

In an embodiment, the method further includes at least one of the following:
when PDU Set Delay Budget (PSDB) is exceeded, performing packet discarding on a PDU set; when PDU Set Error Rate is exceeded, performing packet discarding on a PDU set; in response to delivery failure of a dependent PDU Set, performing packet discarding on a PDU set; in response to delivery failure of an important PDU Set, performing packet discarding on a PDU set; when PDU Set Error Rate is exceeded, performing packet discarding on packets of a PDU set; in response to delivery failure of a dependent Packet in a PDU set, performing packet discarding on packets of a PDU set; in response to delivery failure of an important Packet in a PDU set, performing packet discarding on packets of a PDU set; or when PDU Set Delay Budget (PSDB)is exceeded, performing packet discarding on packets of a PDU set.

It should be noted that those skilled in the art can understand that the methods provided in embodiments of the present disclosure can be executed separately or together with some methods in embodiments of the present disclosure or related arts.

As shown in FIG. 6, this embodiment provides a packet discarding processing method, where the method is performed by a first network function, and the method includes step 61.

In Step 61, via one or more network functions of User Plane (UP), the indication information transmitted by the access network node is received.

In an embodiment, indication information for downlink data flows of a predetermined service is received via one or more network functions of user plane; where the indication information is configured to indicate at least one of: information of a Packet Data Unit (PDU) set based Quality of Service (QoS) handling packets discarding event; or information of a PDU set based QoS handling packets discarding indication. The information of the packets discarding event is configured to indicate the triggering conditions for conditional discarding of data packets; and/or, the information of the packets discarding indication is configured to indicate whether conditional discarding for data packets needs to be performed; or whether conditional discarding for data packets is allowed to be performed.

In an embodiment, the information of the packets discarding indication is configured to indicate whether to perform conditional discarding or non-conditional discarding.

In an embodiment, the triggering condition includes at least one of the following: a degree of network congestion being greater than a degree threshold; a packet error rate (PER) being greater than a packet error rate threshold; a packet delay budget being greater than a packet delay budget threshold; a terminal status being in a predetermined status; where the predetermined status may be a status related to overheating, battery, power mode, and GPU (graphics processing unit) load balancing; matching a packet discarding filter for data flows; matching a packet discarding filter for data packet sets; or matching a packet discarding filter for data packets.

In this way, the indication information can be transmitted to the first network function via one or more network functions of User Plane (UP), achieving packet discarding based on the user plane.

It should be noted that those skilled in the art can understand that the methods provided in embodiments of the present disclosure can be executed separately or together with some methods in embodiments of the present disclosure or related arts.

As shown in FIG. 7, this embodiment provides a packet discarding processing method, where the method is performed by a first network function, and the method includes steps 71 to 72.

In step 71, the indication information is transmitted to a third network function or a fourth network function.

In step 72, packet discarding policy information determined by the third network function or the fourth network function based on the indication information is received, where the packet discarding policy information is configured for performing packet discarding.

Here, the packet discarding policy information indicates a policy of discarding data packets based on factors such as latency and/or packet importance.

In an embodiment, indication information for a predetermined service transmitted by the access network node is received; where the indication information is configured to indicate at least one of: information of a Packet Data Unit (PDU) set based Quality of Service (QoS) handling packets discarding event; or information of a PDU set based QoS handling packets discarding indication. The indication information is transmitted to the third network function or the fourth network function; and the policy information determined by the third network function or the fourth network function based on the indication information is received, where the policy information is configured for performing packet discarding.

In an embodiment, the third network function is, for example, Policy Control Function (PCF). In another embodiment, the fourth network function is, for example, the Session Management Function (SMF).

It should be noted that those skilled in the art can understand that the methods provided in embodiments of the present disclosure can be executed separately or together with some methods in embodiments of the present disclosure or related arts.

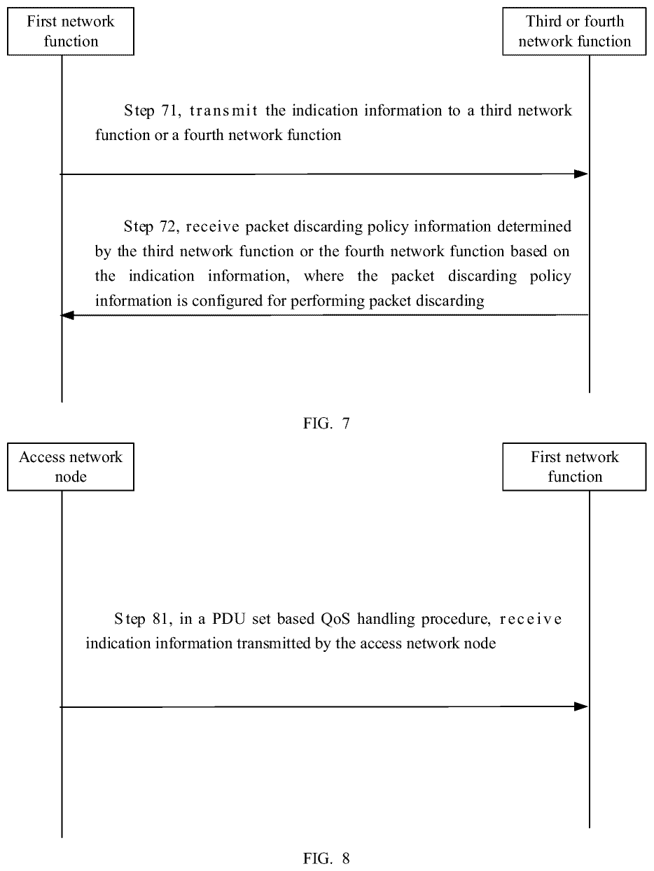

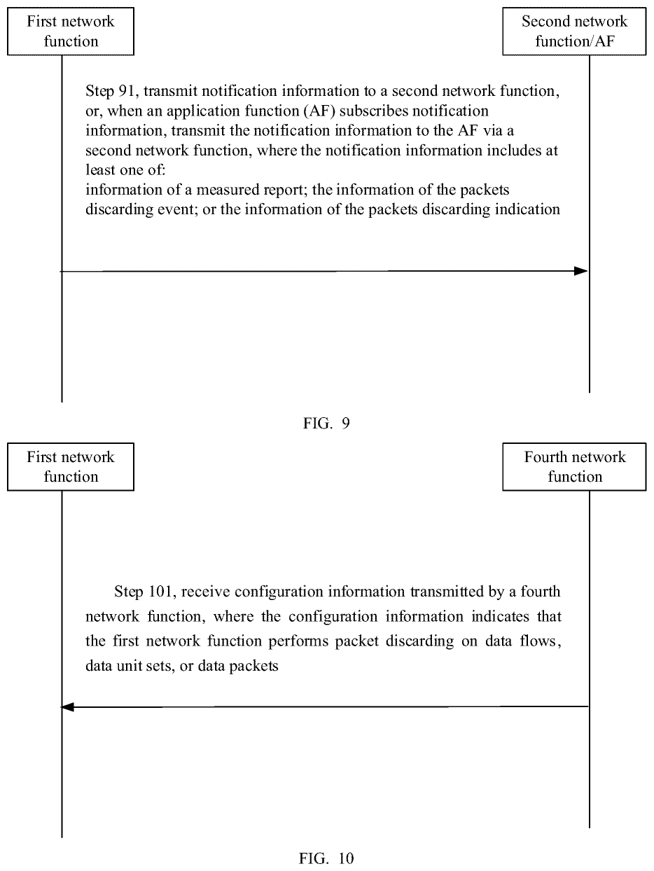

As shown in FIG. 8, this embodiment provides a packet discarding processing method, where the method is performed by a first network function, and the method includes step 81.

In step 81, in a PDU set based QoS handling procedure, indication information transmitted by the access network node is received.

In an embodiment, in procedure of the PDU set based QoS handling, when a packet loss event (such as a network congestion event) occurs, indication information for packets discarding transmitted by the access network node is received; where the indication information is configured to indicate at least one of: information of a Packet Data Unit (PDU) set based Quality of Service (QoS) handling packets discarding event; or information of or a PDU set based QoS handling packets discarding indication. Where the information of the packets discarding indication is carried in a header of an uplink data packet.

In an embodiment, in response to the absence of uplink data packets, the wireless network node creates uplink dummy data packets. In procedure of the PDU set based QoS handling, when a packet loss event (such as a network congestion event) occurs, indication information for packets discarding transmitted by the access network node is received; where the indication information is configured to indicate at least one of: information of a Packet Data Unit (PDU) set based Quality of Service (QoS) handling packets discarding event; or information of or a PDU set based QoS handling packets discarding indication. Where the information of the indication is carried in a created uplink dummy data packet.

In this way, packet discarding processing can be implemented based on the procedure of the existing PDU set based QoS handling.

It should be noted that those skilled in the art can understand that the methods provided in embodiments of the present disclosure can be executed separately or together with some methods in embodiments of the present disclosure or related arts.

As shown in FIG. 9, this embodiment provides a packet discarding processing method, where the method is performed by a first network function, and the method includes step 91.

In step 91, notification information is transmitted to a second network function.

Or, when an application function (AF) subscribes notification information, the notification information is transmitted to the AF via a second network function. Where the notification information includes at least one of: information of a measured report; the information of the packets discarding event; or the information of the packets discarding indication.

In an embodiment, indication information transmitted by the access network node is received; where the indication information is configured to indicate at least one of: information of a PDU set based QoS handling packets discarding event; or information of a PDU set based QoS handling packets discarding indication. Notification information is transmitted to a second network function; or when an application function (AF) subscribes notification information, the notification information is transmitted to the AF via a second network function; where the notification information includes at least one of the following: information of a measured report; information of a packets discarding event; or information of the packets discarding indication.

It should be noted that those skilled in the art can understand that the methods provided in embodiments of the present disclosure can be executed separately or together with some methods in embodiments of the present disclosure or related arts.

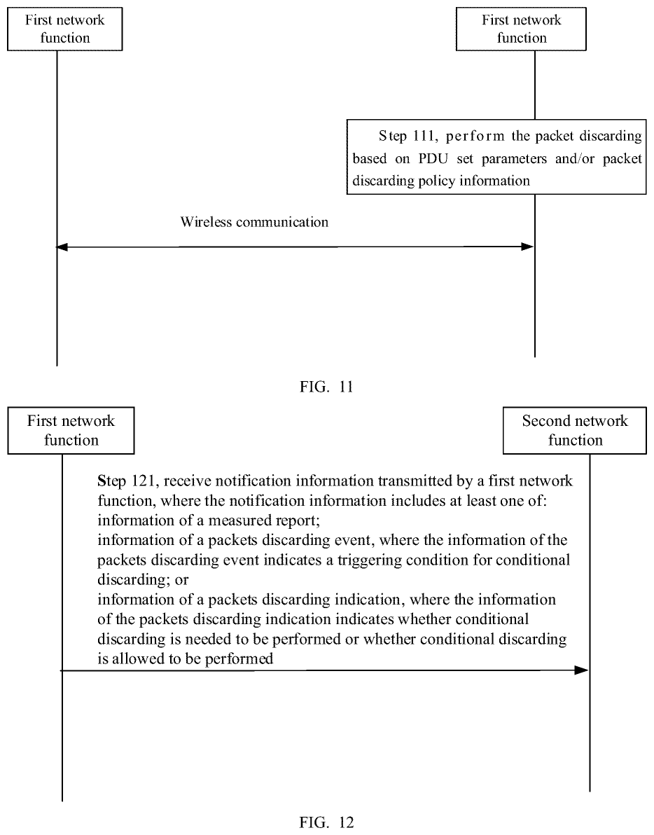

As shown in FIG. 10, this embodiment provides a packet discarding processing method, where the method is performed by a first network function, and the method includes step 101.

In step 101, configuration information transmitted by a fourth network function is received, where the configuration information indicates that the first network function performs packet discarding on data flows, data unit sets, or data packets.

In an embodiment, indication information for a predetermined service transmitted by the access network node is received; where the indication information is configured to indicate at least one of: information of a Packet Data Unit (PDU) set based Quality of Service (QoS) handling packets discarding event; or information of a PDU set based QoS handling packets discarding indication. Configuration information transmitted by a fourth network function is received, where the configuration information indicates that the first network function performs packet discarding on data flows, data unit sets, or data packets.

It should be noted that those skilled in the art can understand that the methods provided in embodiments of the present disclosure can be executed separately or together with some methods in embodiments of the present disclosure or related arts.

As shown in FIG. 11, this embodiment provides a packet discarding processing method, where the method is performed by a first network function, and the method includes step 111.

In step 111, the packet discarding is performed based on PDU set parameters and/or packet discarding policy information.

In some embodiments, performing the packet discarding based on the PDU set parameters and/or the packet discarding policy information includes at least one of: when PDU Set Delay Budget (PSDB) is exceeded, performing packet discarding on a PDU set; when PDU Set Error Rate is exceeded, performing packet discarding on a PDU set; in response to delivery failure of a dependent PDU Set, performing packet discarding on a PDU set; in response to delivery failure of an important PDU Set, performing packet discarding on a PDU set; when PDU Set Error Rate is exceeded, performing packet discarding on packets of a PDU set; in response to delivery failure of a dependent Packet in a PDU set, performing packet discarding on packets of a PDU set; in response to delivery failure of an important Packet in a PDU set, performing packet discarding on packets of a PDU set; or when PDU Set Delay Budget (PSDB)is exceeded, performing packet discarding on packets of a PDU set.

It should be noted that those skilled in the art can understand that the methods provided in embodiments of the present disclosure can be executed separately or together with some methods in embodiments of the present disclosure or related arts.

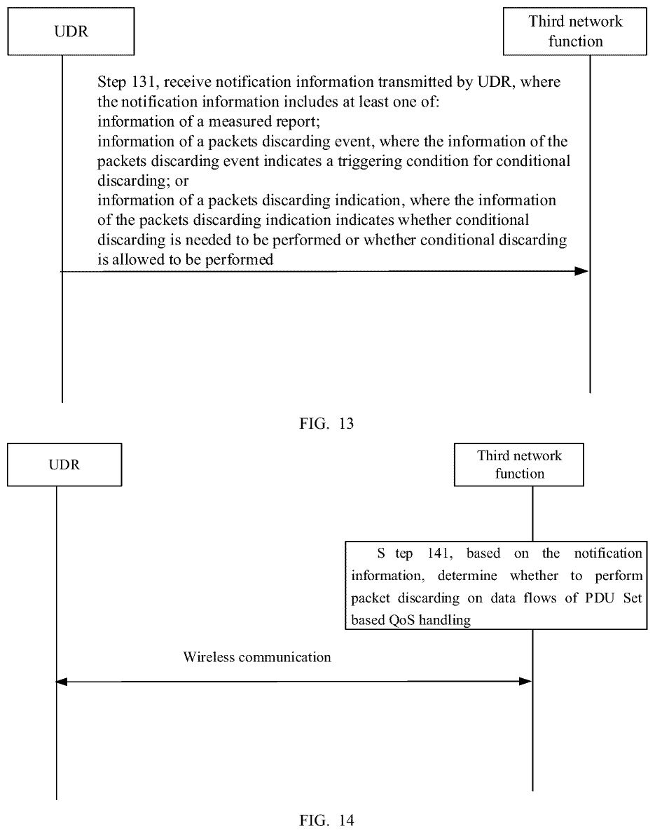

As shown in FIG. 12, this embodiment provides a packet discarding processing method, where the method is performed by a second network function, and the method includes step 121.

In step 121, notification information transmitted by a first network function is received. Where the notification information includes at least one of: information of a measured report; information of a packets discarding event, where the information of the packets discarding event indicates a triggering condition for conditional discarding; or information of a packets discarding indication, where the information of the packets discarding indication indicates whether conditional discarding is needed to be performed or whether conditional discarding is allowed to be performed.

The terminal referred to in the present disclosure may include but are not limited to a mobile phone, a wearable device, an in-vehicle terminal, a Road Side Units (RSU), a smart home terminal, an industrial sensing device, and/or a medical device. In some embodiments, the terminal may be a Redcap terminal or a predetermined version of a new ratio (NR) terminal (e.g., an R17 NR terminal).

The access network node referred to in the present disclosure may be a base station. The base station can be various types of base stations, such as a base station for third-generation mobile communication (3G) networks, a base station for fourth generation mobile communication (4G) networks, a base station for fifth generation mobile communication (5G) networks, or other evolved base stations.

The network functions referred to in the present disclosure can be devices in the core network. For example, the first network function is a User Plane Function (UPF); the second network function is a Network Exposure Function (NEF); the third network function is a Policy Control Function (PCF); and the fourth network function is a Session Management Function (SMF). The network function can also be other evolved network functions, which is not limited here.

In an embodiment, the triggering condition includes at least one of the following: a degree of network congestion being greater than a degree threshold; a packet error rate being greater than a packet error rate threshold; a packet delay budget being greater than a packet delay budget threshold; a terminal status being in a predetermined status; matching a packet discarding filter for data flows; matching a packet discarding filter for data packet sets; or matching a packet discarding filter for data packets.

In an embodiment, notification information transmitted by the first network function is received; where the notification information includes at least one of the following: information of a measured report; information of a packets discarding event, which indicates triggering conditions for conditional discarding; or information of a packets discarding indication, which indicates whether conditional discarding for data packets is required or allowed. The notification information is transmitted to the User Data Repository (UDR).

It should be noted that those skilled in the art can understand that the methods provided in embodiments of the present disclosure can be executed separately or together with some methods in embodiments of the present disclosure or related arts.

As shown in FIG. 13, this embodiment provides a packet discarding processing method, where the method is performed by a third network function, and the method includes step 131.

In step 131, notification information transmitted by UDR is received.

Where the notification information includes at least one of: information of a measured report; information of a packets discarding event, where the information of the packets discarding event indicates a triggering condition for conditional discarding; or information of a packets discarding indication, where the information of the packets discarding indication indicates whether conditional discarding is needed to be performed or whether conditional discarding is allowed to be performed.

The terminal referred to in the present disclosure may include but are not limited to a mobile phone, a wearable device, an in-vehicle terminal, a Road Side Units (RSU), a smart home terminal, an industrial sensing device, and/or a medical device. In some embodiments, the terminal may be a Redcap terminal or a predetermined version of a new ratio (NR) terminal (e.g., an R17 NR terminal).

The access network node referred to in the present disclosure may be a base station. The base station can be various types of base stations, such as a base station for third-generation mobile communication (3G) networks, a base station for fourth generation mobile communication (4G) networks, a base station for fifth generation mobile communication (5G) networks, or other evolved base stations.

The network functions referred to in the present disclosure can be devices in the core network. For example, the first network function is a User Plane Function (UPF); the second network function is a Network Exposure Function (NEF); the third network function is a Policy Control Function (PCF); and the fourth network function is a Session Management Function (SMF). The network function can also be other evolved network functions, which is not limited here.

In an embodiment, notification information transmitted by the UDR is received; where the notification information includes at least one of the following: information of a measured report; information of a packets discarding event, which indicates triggering conditions for conditional discarding; or information of a packets discarding indication, which indicates whether conditional discarding for data packets is required or allowed. The triggering condition includes at least one of the following: a degree of network congestion being greater than a degree threshold; a packet error rate being greater than a packet error rate threshold; a packet delay budget being greater than a packet delay budget threshold; a terminal status being in a predetermined status; matching a packet discarding filter for data flows; matching a packet discarding filter for data packet sets; or matching a packet discarding filter for data packets.

In an embodiment, the notification information is subscribed to; and notification information transmitted by the UDR is the notification information to received; where the notification information includes at least one of the following: information of a measured report; information of a packets discarding event, which indicates triggering conditions for conditional discarding; or information of a packets discarding indication, which indicates whether conditional discarding for data packets is required or allowed.

In an embodiment, notification information transmitted by the UDR is received; where the notification information includes at least one of the following: information of a measured report; information of a packets discarding event, which indicates triggering conditions for conditional discarding; or information of a packets discarding indication, which indicates whether conditional discarding for data packets is required or allowed. Based on the notification information, it is determined whether to perform packet discarding on data flows of PDU Set based QoS handling.

In an embodiment, notification information transmitted by the UDR is received; where the notification information includes at least one of the following: information of a measured report; information of a packets discarding event, which indicates triggering conditions for conditional discarding; or information of a packets discarding indication, which indicates whether conditional discarding for data packets is required or allowed. Based on the notification information, it is determined whether to perform packet discarding on data flows of PDU Set based QoS handling. In response to determining to perform the packet discarding on the data flows of PDU Set based QoS handling, authorization information is transmitted to a fourth network function; where the authorization information is configured to indicate performing of packet discarding on data flows, data unit sets, or data packets.

In an embodiment, notification information transmitted by the UDR is received; where the notification information includes at least one of the following: information of a measured report; information of a packets discarding event, which indicates triggering conditions for conditional discarding; or information of a packets discarding indication, which indicates whether conditional discarding for data packets is required or allowed. Based on the notification information, it is determined whether to perform packet discarding on data flows of PDU Set based QoS handling. In response to determining to perform the packet discarding on the data flows of PDU Set based QoS handling, authorization information is transmitted to a fourth network function in the PDU session modification procedure; where the authorization information is configured to indicate performing of packet discarding on data flows, data unit sets, or data packets.

In an embodiment, indication information transmitted by a first network function is received, where the indication information includes the information of a packets discarding event and information of a packets discarding indication; packet discarding policy information is determined based on the indication information, where the packet discarding policy information is configured to perform packet discarding; and the packet discarding policy information is transmitted to the first network function.

It should be noted that those skilled in the art can understand that the methods provided in embodiments of the present disclosure can be executed separately or together with some methods in embodiments of the present disclosure or related arts.

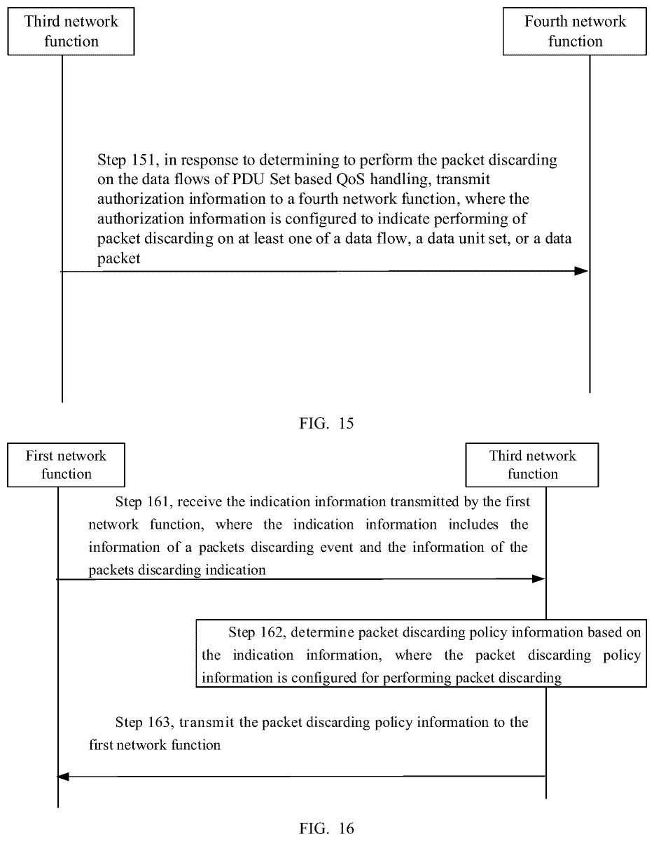

As shown in FIG. 14, this embodiment provides a packet discarding processing method, where the method is performed by a third network function, and the method includes step 141.

In step 141, based on the notification information, it is determined whether to perform packet discarding on data flows of PDU Set based QoS handling.

In an embodiment, the notification information is subscribed to; and notification information transmitted by the UDR is the notification information to received; where the notification information includes at least one of the following: information of a measured report; information of a packets discarding event, which indicates triggering conditions for conditional discarding; or information of a packets discarding indication, which indicates whether conditional discarding for data packets is required or allowed. Based on the notification information, it is determined whether to perform packet discarding on data flows of PDU Set based QoS handling.

It should be noted that those skilled in the art can understand that the methods provided in embodiments of the present disclosure can be executed separately or together with some methods in embodiments of the present disclosure or related arts.

As shown in FIG. 15, this embodiment provides a packet discarding processing method, where the method is performed by a third network function, and the method includes step 151.

In step 151, in response to determining to perform the packet discarding on the data flows of PDU Set based QoS handling, authorization information is transmitted to a fourth network function.

Where the authorization information is configured to indicate performing of packet discarding on at least one of a data flow, a data unit set, or a data packet.

In an embodiment, the notification information is subscribed to; and notification information transmitted by the UDR is the notification information to received; where the notification information includes at least one of the following: information of a measured report; information of a packets discarding event, which indicates triggering conditions for conditional discarding; or information of a packets discarding indication, which indicates whether conditional discarding for data packets is required or allowed. Based on the notification information, it is determined whether to perform packet discarding on data flows of PDU Set based QoS handling. In response to determining to perform the packet discarding on the data flows of PDU Set based QoS handling, authorization information is transmitted to the fourth network function; where the authorization information is configured to indicate performing of packet discarding on at least one of the data flows, data unit sets, or data packets.

In an embodiment, the notification information is subscribed to; and notification information transmitted by the UDR is the notification information to received; where the notification information includes at least one of the following: information of a measured report; information of a packets discarding event, which indicates triggering conditions for conditional discarding; or information of a packets discarding indication, which indicates whether conditional discarding for data packets is required or allowed. Based on the notification information, it is determined whether to perform packet discarding on data flows of PDU Set based QoS handling. In response to determining to perform the packet discarding on the data flows of PDU Set based QoS handling, authorization information is transmitted to a fourth network function in the PDU session modification procedure; where the authorization information is configured to indicate performing of packet discarding on at least one of a data flow, a data unit set, or a data packet.

It should be noted that those skilled in the art can understand that the methods provided in embodiments of the present disclosure can be executed separately or together with some methods in embodiments of the present disclosure or related arts.

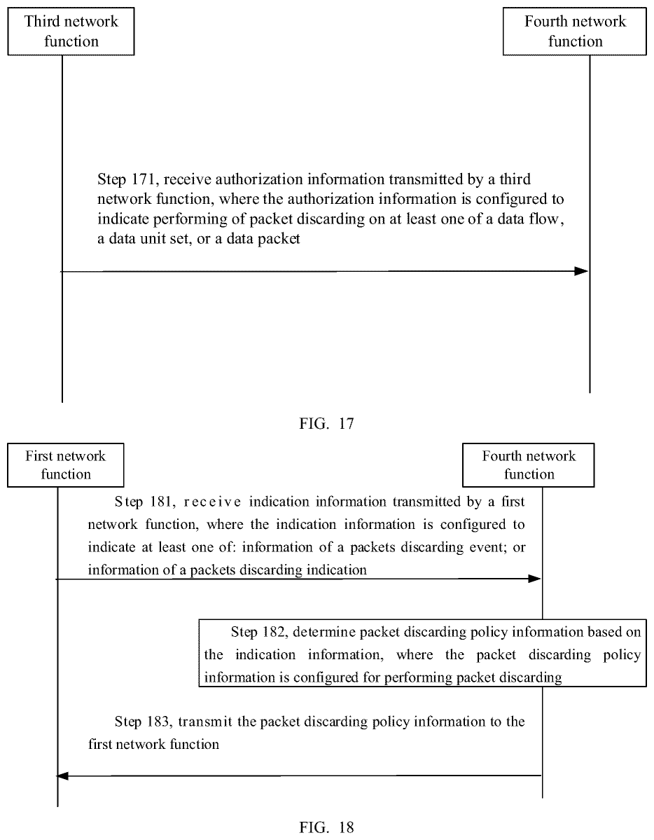

As shown in FIG. 16, this embodiment provides a packet discarding processing method, where the method is performed by a third network function, and the method includes steps 161 to 163.

In step 161, the indication information transmitted by the first network function is received, where the indication information includes the information of a packets discarding event and the information of the packets discarding indication.

In step 162, packet discarding policy information is determined based on the indication information, where the packet discarding policy information is configured for performing packet discarding.

In step 163, the packet discarding policy information is transmitted to the first network function.

It should be noted that those skilled in the art can understand that the methods provided in embodiments of the present disclosure can be executed separately or together with some methods in embodiments of the present disclosure or related arts.

As shown in FIG. 17, this embodiment provides a packet discarding processing method, where the method is performed by a fourth network function, and the method includes step 171.

In step 171, authorization information transmitted by a third network function is received. Where the authorization information is configured to indicate performing of packet discarding on at least one of a data flow, a data unit set, or a data packet.

The terminal referred to in the present disclosure may include but are not limited to a mobile phone, a wearable device, an in-vehicle terminal, a Road Side Units (RSU), a smart home terminal, an industrial sensing device, and/or a medical device. In some embodiments, the terminal may be a Redcap terminal or a predetermined version of a new ratio (NR) terminal (e.g., an R17 NR terminal).

The access network node referred to in the present disclosure may be a base station. The base station can be various types of base stations, such as a base station for third-generation mobile communication (3G) networks, a base station for fourth generation mobile communication (4G) networks, a base station for fifth generation mobile communication (5G) networks, or other evolved base stations.

The network functions referred to in the present disclosure can be devices in the core network. For example, the first network function is a User Plane Function (UPF); the second network function is a Network Exposure Function (NEF); the third network function is a Policy Control Function (PCF); and the fourth network function is a Session Management Function (SMF). The network function can also be other evolved network functions, which is not limited here.

In an embodiment, authorization information transmitted by a third network function is received; where the authorization information is configured to indicate performing of packet discarding on data flows, data unit sets, or data packets. Configuration information is transmitted to a first network function, where the configuration information indicates that the first network function performs packet discarding on at least one of a data flow, a data unit set, or a data packet.

In an embodiment, indication information transmitted by a first network function is received, where the indication information is configured to indicate at least one of: information of a Packet Data Unit (PDU) set based Quality of Service (QoS) handling packets discarding event; or information of or a PDU set based QoS handling packets discarding indication; packet discarding policy information is determined based on the indication information, where the packet discarding policy information is configured to perform packet discarding; and the packet discarding policy information is transmitted to the first network function.

It should be noted that those skilled in the art can understand that the methods provided in embodiments of the present disclosure can be executed separately or together with some methods in embodiments of the present disclosure or related arts.

As shown in FIG. 18, this embodiment provides a packet discarding processing method, where the method is performed by a fourth network function, and the method includes steps 181 to 183.

In step 181, indication information transmitted by a first network function is received, where the indication information is configured to indicate at least one of: information of a Packet Data Unit (PDU) set based Quality of Service (QoS) handling packets discarding event; or information of a PDU set based QoS handling packets discarding indication.

In step 182, packet discarding policy information is determined based on the indication information, where the packet discarding policy information is configured for performing packet discarding.

In step 183, the packet discarding policy information is transmitted to the first network function.

It should be noted that those skilled in the art can understand that the methods provided in embodiments of the present disclosure can be executed separately or together with some methods in embodiments of the present disclosure or related arts.

In order to better understand the embodiments of the present disclosure, the following will further illustrate the present disclosure through an embodiment.

### Embodiment 1

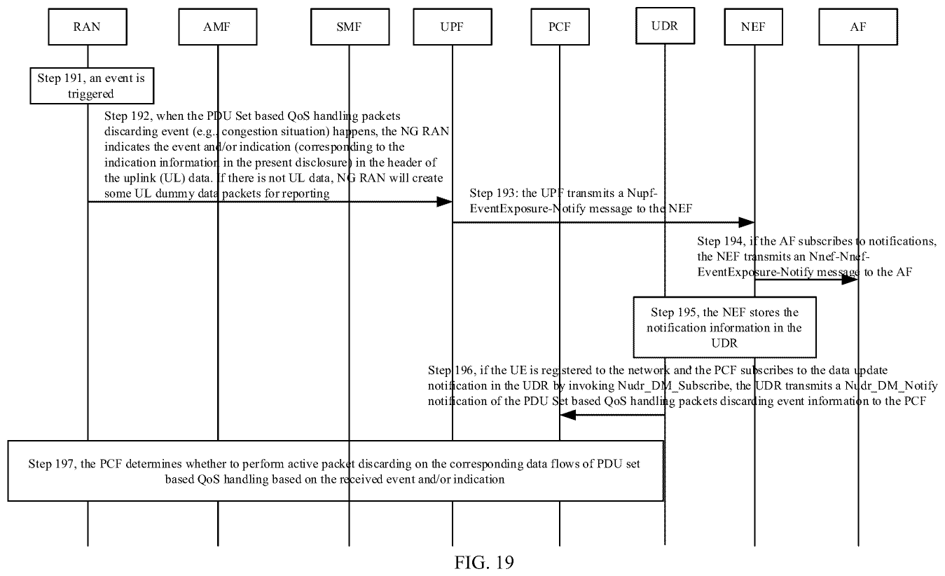

Referring to FIG. 19, a packet discarding processing method is provided, where the method includes steps 191 to 197.

In step 191, an event is triggered.

In an embodiment, a network congestion event is triggered.

In step 192, when the PDU Set based QoS handling packets discarding event (e.g., congestion situation) happens, the NG RAN indicates the event and/or indication (corresponding to the indication information in the present disclosure) in the header of the uplink (UL) data. If there is not UL data, NG RAN will create some UL dummy data packets for reporting.

In step 193: the UPF transmits a Nupf-EventExposure-Notify message to the NEF, where the Nupf-EventExposure-Notify message includes at least one of a measurement report, an event, or an indication information.

In step 194, if the AF subscribes to notifications, the NEF transmits a Nnef-Nnef-EventExposure-Notify message to the AF, where the Nupf-EventExposure-Notify message includes at least one of a measurement report, an event, or an indication information.

In step 195, the NEF stores the notification information in the UDR.

In step 196, if the UE is registered to the network and the PCF subscribes to the data update notification in the UDR by invoking Nudr_DM_Subscribe, the UDR transmits a Nudr_DM_Notify notification of the PDU Set based QoS handling packets discarding event information to the PCF; where Nudr_DM_Subscribe can include the PDU Set based QoS handling packets discarding event information and Subscription Permanent Identifier (SUPI) information.

In step 197, the PCF determines whether to perform active packet discarding on the corresponding data flows of PDU set based QoS handling based on the received event and/or indication. It should be noted that if the PCF is not deployed, SMF performs corresponding session modifications and rule updates.

PCF initiates the PDU session modification procedure, to notify or authorize SMF to perform active packet discarding on the corresponding service data flows, data unit sets, and/or data packets. SMF configures UPF based on updated rules, and UPF performs active packet discarding on corresponding service data flows, data unit sets, and/or data packets.

Specific packet discarding can be performed by combining PDU set parameters and packet discarding policies. For example, based on the latency or importance of the PDU set, the data packets of the PDU set are discarded in whole or in part. Packet discarding is performed based on the packet discarding window. Based on the priority of different data flows, packet discarding is performed on data flows with specific latency or importance (for example, in audio and video calls, audio is retained and video flow data packets are selectively discarded).

In embodiments of the present disclosure, NG RAN transmits indication information to PDU; where the indication information is configured to indicate at least one of: information of a Packet Data Unit (PDU) set based Quality of Service (QoS) handling packets discarding event; or information of a PDU set based QoS handling packets discarding indication. Here, since the NG RAN transmits information of a Packet Data Unit (PDU) set based Quality of Service (QoS) handling packets discarding event and/or information of a PDU set based QoS handling packets discarding indication to the PDU, upon receiving the information of the packets discarding event and/or information of the packets discarding indication, the PDU can perform packets discarding processing based on the information of the packets discarding event and/or information of the packets discarding indication. Compared to a method where indication information is not transmitted, the network can perform packets discarding based on the indication information, which improves the transmission efficiency of service data flows, enhances QoS, and brings a good user experience when congestion occurs.

### Embodiment 2

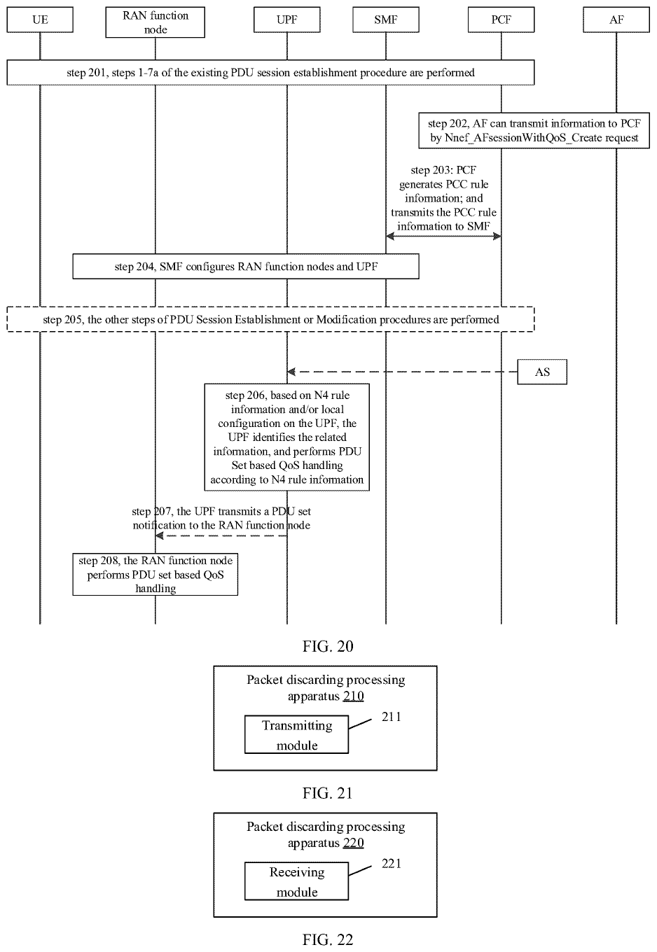

Referring to FIG. 20, a packet discarding processing method is provided.

PDU set based Policy and Charging Control can happen during the PDU session establishment or modification procedure. The embodiments of the present disclosure are performed by a communication device, where the communication device includes UE, RAN node, AMF, SMF, PCF, UPF, or AF. The information processing method includes the following steps 201 to 208.

In step 201, steps 1-7a of the existing PDU session establishment procedure are performed.

In step 202, AF can transmit information to PCF by Nnef_AFsession WithQoS_Create request.

Here, the information can be the QoS parameters of each PDU set in the QoS flow and/or parameters related to frame identification. AF can also provide the information to 5GS prior to PDU Session Establishment.

The QoS parameters of each PDU set in the QoS flow include at least one of the following: PDU set handling indication, where the PDU set handling indication is configured to indicate whether PDU set based handling is activated to a data flow; indicate whether all PDU parameters are needed for the usage of PDU Set by application layer; PDU Set Delay Budget (PSDB); PDU set error rate. Where the parameters of frame identification include burst periodicity.

In step 203: PCF generates PCC rule information; and transmits the PCC rule information to SMF.

Here, PCC rule information may include QoS parameters. PC and/or SMF generate rule information to perform transfer optimization or selective traffic control (such as active packet discarding triggered by congestion events) on downflow XRM data flows; where the prediction results of UPF transfer can be the network analysis results (network congestion) of NWDAF, or the event notification results (such as network congestion) reported by RAN functional nodes. The prediction results are considered in PCF decision-making to generate PCC rule information.

Where the QoS parameters related to the PDU set are new QoS parameters for QoS handling of PDU sets in 5GS. QoS parameters include one of the following indications:

PDU Set Delay Budget (PSDB); PDU set error rate; indicate whether all PDU parameters are needed for the usage of PDU Set by application layer; a parameter indicating whether a PDU set needs to be discarded when PSDB is exceeded; or a priority of a PDU set or a priority of a PDU. The “PDU Set Priority” is the same for all PDU Sets (i.e., same as existing QoS Flow Priority) or is different for each PDU Set (i.e., same as “PDU Set importance”).

This step is done in step 7b in PDU Session Establishment procedure, or Step 1b in PDU Session Modification procedure. (PDU Session Establishment procedure, PDU Session Modification procedure).

If this step is triggered by step 1b, the PCF generates the PCC rules considering the information provided by the AF.

In step 204, SMF configures RAN function nodes and UPF.

The SMF generates the QoS configuration files and N4 rules based on the PCC rules from PCF. SMF transmits N4 rule information to UPF and transmits QoS configuration files to RAN function nodes via AMF.

Here, this step is done via steps 8-15 in PDU Session Establishment procedure, or steps 27 in PDU Session Modification procedure.

In step 205, the other steps of PDU Session Establishment or Modification procedures are performed.

In step 206, based on N4 rule information and/or local configuration on the UPF, the UPF identifies the related information, and performs PDU Set based QoS handling according to N4 rule information.

Here, the relevant information identified by UPF includes at least one of the following: UPF generates and distributes rule information based on previously installed PCF and/or SMF; and performs transfer optimization and/or selective packet discarding (e.g. active selective packet discarding triggered by congestion events) on downlink XRM data. The optimization granularity can be: data flows, PDU sets, or data packets. The optimization conditions can be: a predetermined time window, a predetermined traffic threshold, or a predetermined packet loss ratio (packet error rate threshold).

UPF identifies PDUs belonging to a PDU set and at least one of the following information for each PDU set:

PDU Set Sequence number (SN) (The QoS Flow is identified using QoS Flow ID and each PDU Set within the QoS Flow is identified using PDU Set SN); where ach QoS Flow can be used to deliver one or more PDU Set; the beginning or end of a PDU set; PDU SN in a PDU set; or the number of PDUs in a PDU set.

The information for inter-PDU Set handling includes at least one of the following:

PDU Set importance; or PDU Set dependency.

Here, the UPF identifies the related information via the methods/mechanisms described as follows:

Option 1: by matching RTP (Real-time Transport Protocol) /SRTP (Secure Real-time Transport Protocol) header and payload; Option 2: new RTP extension header; Option 3: by information provided by the AS (Access Stratum) in N6 encapsulation header, e.g., GTP-U (GTP User Plane); Option 4: by detection based on traffic characteristics; Option 5: by non-standardized mechanisms UPF implementation.

In step 207, the UPF transmits a PDU set notification to the RAN function node.

Here, UPF provides the PDU Set related information (listed in the related information in step 1205) to the RAN function node.

For PDU Set importance, at least one of the following can be selected:

Option 1: UPF classifies the downlink (DL) traffics into different QoS Flows based on PDU Set importance; Option 2: UPF classifies the DL traffics into different sub-QoS Flows based on PDU Set importance; or Option 3: UPF adds PDU Set importance into GTP-U header.

For other PDU Sets related info in step 5, the UPF adds them into GTP-U Header.

In step 208, the RAN function node performs PDU set based QoS handling.

Here, based on the relevant information of the PDU set received in step S206, PDU set based QoS handling is performed.

If monitoring and reporting of prediction conditions is performed for the RAN function node, in the PDU set based QoS handling procedure, when a packet discarding triggering event is detected (such as congestion level greater than a threshold, packet error rate greater than a threshold, packet delay budget greater than a threshold, or UE status related requirements, etc.), the RAN function node reports the information of a PDU set based QoS handling packets discarding event and/or information of a PDU set based QoS handling packets discarding indication to the core network (CN).

The CN-CP function determines whether to perform packet discarding (such as active packet discarding) on the PDU set based QoS handling packets based on the information of a PDU set based QoS handling packets discarding event and/or information of a PDU set based QoS handling packets discarding indication.

For example, the information of a PDU set based QoS handling packets discarding event is configured to indicate the trigger/conditions of XRM service downlink traffic conditional discarding. These trigger conditions include network congestion (network congestion level, congestion parameter greater than congestion threshold), packet error rate greater than packet error rate threshold, packet delay budget greater than packet delay budget threshold, or UE status related requirements. Where UE status related requirements include overheating, battery, power mode status, and/or GPU load balancing status requirements.

For example, the information of a PDU set based QoS handling packets discarding event is configured to indicate whether it is necessary to perform conditional discarding of downlink XRM service data flows, or to indicate whether to allow the packets discarding of downflow XRM service data flows that meet the conditions.

As shown in FIG. 21, the embodiments of the present disclosure provide a packet discarding processing apparatus 210, where the device includes:
a transmitting module 211, configured to transmit indication information to a first network function. Where the indication information is configured to indicate at least one of the following: information of a Packet Data Unit (PDU) set based Quality of Service (QoS) handling packets discarding event; or information of a PDU set based QoS handling packets discarding indication.

It should be noted that those skilled in the art can understand that the methods provided in embodiments of the present disclosure can be executed separately or together with some methods in embodiments of the present disclosure or related arts.

As shown in FIG. 22, the embodiments of the present disclosure provide a packet discarding processing apparatus 220, where the device includes:
a receiving module 221, configured to receive indication information transmitted by an access network node. Where the indication information is configured to indicate at least one of the following: information of a PDU set based QoS handling packets discarding event; or information of a PDU set based QoS handling packets discarding indication.

It should be noted that those skilled in the art can understand that the methods provided in embodiments of the present disclosure can be executed separately or together with some methods in embodiments of the present disclosure or related arts.

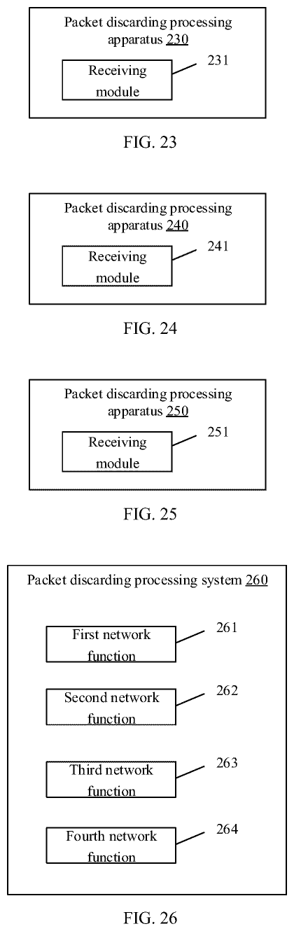

As shown in FIG. 23, the embodiments of the present disclosure provide a packet discarding processing apparatus 230, where the device includes:
a receiving module 231, configured to receive notification information transmitted by a first network function, where the notification information includes at least one of: information of a measured report; information of a packets discarding event, where the information of the packets discarding event indicates a triggering condition for conditional discarding; or information of a packets discarding indication, where the information of the packets discarding indication indicates whether conditional discarding is needed to be performed or whether conditional discarding is allowed to be performed.

It should be noted that those skilled in the art can understand that the methods provided in embodiments of the present disclosure can be executed separately or together with some methods in embodiments of the present disclosure or related arts.

As shown in FIG. 24, the embodiments of the present disclosure provide a packet discarding processing apparatus 240, where the device includes:
a receiving module 241, configured to receive notification information transmitted by UDR. Where the notification information includes at least one of: information of a measured report; information of a packets discarding event, where the information of the packets discarding event indicates a triggering condition for conditional discarding; or information of a packets discarding indication, where the information of the packets discarding indication indicates whether conditional discarding is needed to be performed or whether conditional discarding is allowed to be performed.

It should be noted that those skilled in the art can understand that the methods provided in embodiments of the present disclosure can be executed separately or together with some methods in embodiments of the present disclosure or related arts.

As shown in FIG. 25, the embodiments of the present disclosure provide a packet discarding processing apparatus 250, where the device includes:
a receiving module 251, configured to receive authorization information transmitted by a third network function. Where the authorization information is configured to indicate performing of packet discarding on data flows, data unit sets, or data packets.

It should be noted that those skilled in the art can understand that the methods provided in embodiments of the present disclosure can be executed separately or together with some methods in embodiments of the present disclosure or related arts.

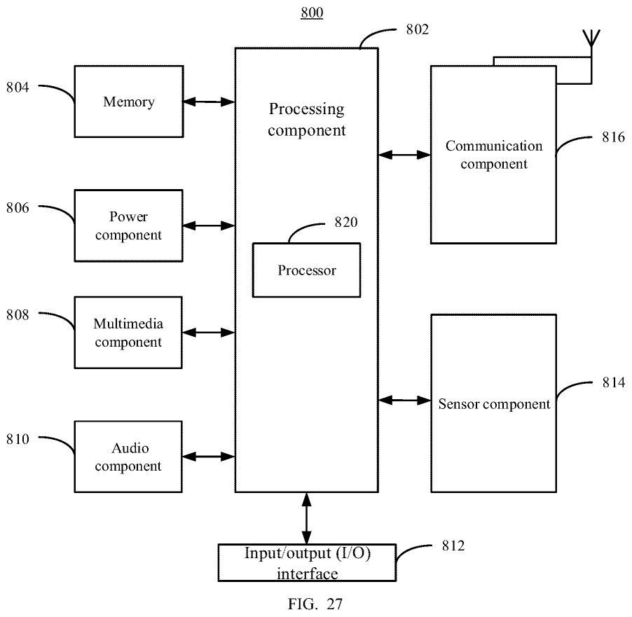

As shown in FIG. 26, the present embodiment provides a wireless communication system 260 for proximity service (ProSe), including a first network function 261, a second network function 262, a third network function 263, and a fourth network function 264. The first network function 261 is configured to perform any one of the methods in the present disclosure performed by the first network function 261, the second network function 262 is configured to perform any one of the methods in the present disclosure performed by the second network function 262, the third network function 263 is configured to perform any one of the methods in the present disclosure performed by the third network function 263, and the fourth network function 264 is configured to perform any one of the methods in the present disclosure performed by the fourth network function 264.

It should be noted that those skilled in the art can understand that the methods provided in embodiments of the present disclosure can be executed separately or together with some methods in embodiments of the present disclosure or related arts.

The embodiments of the present disclosure provide a communication device including: one or more processors; and one or more memories storing instructions executable by the processor; and where the one or more processors are configured to execute the executable instructions to implement the method according to any one of the embodiments of the present disclosure.

The processor may include various types of storage media, which are non-transitory computer storage media that can continue to retain information stored thereon after the communication device loses power.

The processor may be connected to the memory via a bus or the like, and may be used to read an executable program stored in the memory.

The embodiments of the present disclosure further provide a computer storage medium, where the computer storage medium stores a computer executable program, where when the executable program is performed by one or more processors, the method according to any one of the embodiments of the present disclosure is implemented.

Regarding the apparatuses in the examples, the specific manner in which each module performs operations has been described in detail in the examples of the methods, and will not be described in detail here.

As shown in FIG. 27, an embodiment of the present disclosure provides a structure of a terminal.

Referring to FIG. 27, this embodiment provides a terminal 800, which can be a mobile phone, a computer, a digital broadcast terminal, a message transceiving device, a game console, a tablet device, a medical device, a fitness device and a personal digital assistant and etc.

Referring to FIG. 27, the terminal 800 can include one or more of the following components: processing component 802, memory 804, power component 806, multimedia component 808, audio component 810, input/output (I/O) interface 812, sensor component 814, or a communication component 816.

The processing component 802 generally controls overall operations of the terminal 800, such as operations associated with display, phone calls, data communications, camera operations, and recording operations. The processing assembly 802 may include one or more processors 820 to execute instructions to complete all or a part of the blocks of the methods. Further, the processing component 802 may include one or more modules to facilitate interaction between the processing component 802 and another component. For example, the processing component 802 may include a multimedia module to facilitate the interaction between the multimedia component 808 and the processing component 802.

The memory 804 is configured to store different types of data to support operations at the terminal 800. Examples of such data include instructions for any application or method operated on the terminal 800, contact data, phonebook data, messages, pictures, videos, and so on. The memory 804 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or a CD.

The power supply component 806 supplies power for different components of the terminal 800. The power supply component 806 can include a power supply management system, one or more power supplies, and other components associated with generating, managing and distributing power for the terminal 800.

The multimedia component 808 includes a screen providing an output interface between the terminal 800 and the user. In some examples, the screen may include a Liquid Crystal Display (LCD) and a Touch Panel (TP). If the screen includes a touch panel, the screen may be implemented as a touch screen for receiving an input signaling from a user. The touch panel may include one or more touch sensors for sensing a touch, a slide and a gesture on the touch panel. The touch sensor may not only sense the boundary of a touch or slide operation but also detect duration and pressure relating to the touch or slide operation. In some examples, the multimedia component 808 may include a front camera and/or a rear camera. When the apparatus 800 is in an operation mode, such as a shooting mode or a video mode, the front camera and/or the rear camera may receive external multimedia data. Each of the front camera and the rear camera may be a fixed optical lens system or be of a focal length and a capability of an optical zoom.

The audio component 810 is configured to output and/or input an audio signaling. For example, the audio component 810 includes a microphone (MIC). When the terminal 800 is in an operating mode, such as a call mode, a record mode and a voice recognition mode, the microphone is to receive an external audio signal. The received audio signaling may be further stored in the memory 804 or transmitted via the communication component 816. In some examples, the audio component 810 also includes a loudspeaker for outputting an audio signal.

The I/O interface 812 may provide an interface between the processing component 802 and peripheral interface modules. The peripheral interface modules may include a keyboard, a click wheel, buttons and so on. These buttons may include but not limited to, a home button, a volume button, a start button and a lock button.

The sensor component 814 includes one or more sensors to provide status assessments of various aspects for the terminal 800. For example, the sensor component 814 may detect an on/off state of the terminal 800 and a relative location of components. For example, the components are a display and a keypad of the terminal 800. The sensor component 814 may also detect a position change of the terminal 800 or a component of the terminal 800, presence or absence of a touch of a user on the terminal 800, an orientation or acceleration/deceleration of the terminal 800, and a temperature change of terminal 800. The sensor component 814 may include a proximity sensor for detecting the existence of a nearby object without any physical touch. The sensor component 814 may also include an optical sensor, such as a CMOS or CCD image sensor used in an imaging application. In some examples, the sensor component 814 may also include an acceleration sensor, a gyro sensor, a magnetic sensor, a pressure sensor, or a temperature sensor.

The communication component 816 is to facilitate wired or wireless communication between the terminal 800 and other devices. The terminal 800 can access a wireless network according to a communication standard, such as Wi-Fi, 2G or 3G, or any combination thereof. In some embodiments, the communication component 816 may receive a broadcast signal or broadcast-related information from an external broadcast management system via a broadcast channel. In some embodiments, the communication assembly 816 may also include a Near Field Communication (NFC) module to facilitate short-range communications. For example, the NFC module may be implemented based on a Radio Frequency Identification (RFID) technology, an Infrared Data Association (IrDA) technology, an Ultra Wideband (UWB) technology, a Bluetooth® (BT) technology and other technologies.

In an example, the terminal 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components for performing the method described.

In an example, a non-transitory computer readable storage medium including instructions, such as the memory 804 including instructions, is also provided. The instructions may be performed by the processor 820 of the terminal 800 to complete the methods. For example, the non-transitory computer-readable storage medium may be a ROM, a RAM, a CD-ROM, a magnetic tape, a floppy disc, an optical data storage device, and the like.

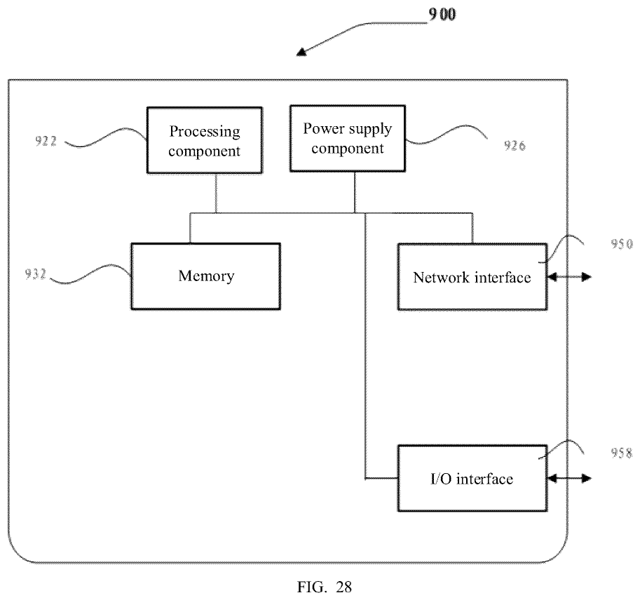

As shown in FIG. 28, a structure of a base station is illustrated in an embodiment of the present disclosure. For example, the base station 900 may be provided as a network device. Referring to FIG. 28, the base station 900 includes a processing component 922, which further includes one or more processors, and a memory resource represented by a memory 932 for storing instructions, such as applications, that can be performed by the processing component 922. The application stored in the memory 932 may include one or more modules and each module corresponds to a set of instructions. In addition, the processing component 922 is configured to execute instructions to perform any one of the methods applied to the base station.

The base station 900 may also include a power supply component 926 configured to perform power management of the base station 900, a wired or wireless network interface 950 configured to connect the base station 900 to the network, and an input-output (I/O) interface 958. The base station 900 can operate an operating system stored in the memory 932, such as Windows Server™, Mac OS X™, Unix™, Linux™, FreeBSD™, or the like.

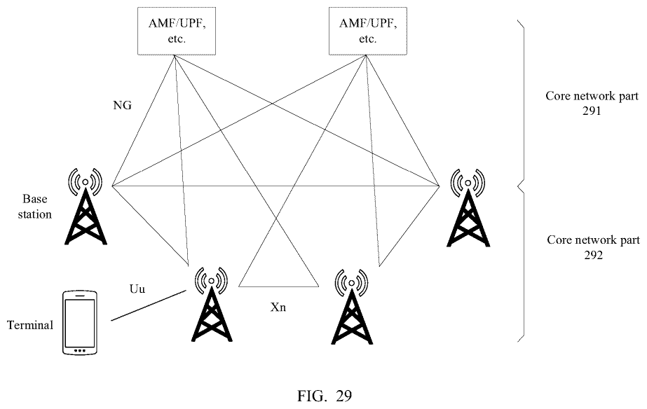

As shown in FIG. 29, an embodiment of the present disclosure illustrates a network architecture of a 5G system, including a core network part 291 and an access network part 292. Where the core network part includes a core network device, where the core network device mainly includes communication nodes such as Access and Mobility Management Function (AMF), User Plane Function (UPF), Network Exposure Function (NEF), User Data Repository (UDR), and Session Management Function (SMF). The access network includes base stations. Where AMF is mainly responsible for various functions related to registration management, connection management, access management, mobility management, and security and access management and authorization. UPF is mainly responsible for various functions related to data plane anchor points, PDU session points connecting data networks, message routing and forwarding, traffic usage reporting, and legitimate monitoring. NEF is mainly responsible for providing security channels to expose 3GPP network functions to AF, and providing security channels for AF to provide information to 3GPP network functions. UDR is mainly responsible for storing important process data during wireless communication. SMF is mainly responsible for various functions related to session management, charging and QoS policy control, legitimate monitoring, charging data collection, and downlink data notification.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the art that are not disclosed in the present disclosure. The specification and embodiments herein are intended to be illustrative only and the real scope and spirit of the present disclosure are indicated by the following claims of the present disclosure.

It is to be understood that the present disclosure is not limited to the precise structures described and shown in the accompanying drawings and may be modified or changed without departing from the scope of the present disclosure. The scope of protection of the present disclosure is limited only by the appended claims.

1. A packet discarding processing method, performed by an access network node, comprising:
transmitting indication information to a first network function, and
wherein the indication information is configured to indicate at least one of:
information of a Packet Data Unit (PDU) set based Quality of Service (QoS) handling packets discarding event, or
information of a PDU set based QoS handling packets discarding indication.

2. The method according to claim 1, wherein,
the information of the packets discarding event is configured to indicate a triggering condition for conditional discarding; and
the information of the PDU set based QoS handling packets discarding indication is configured to indicate whether conditional discarding is needed to be performed or whether conditional discarding is allowed to be performed.

3. The method according to claim 2, wherein the triggering condition comprises at least one of:
a degree of network congestion being greater than a degree threshold;
a packet error rate being greater than a packet error rate threshold;
a packet delay budget being greater than a packet delay budget threshold;
a terminal status being in a predetermined status;
matching a packet discarding filter for data flows;
matching a packet discarding filter for data packet sets; or
matching a packet discarding filter for data packets.

4. The method according to claim 1, wherein transmitting the indication information to the first network function comprises:
transmitting the indication information to the first network function via one or more network functions of User Plane (UP).

5. The method according to claim 1, wherein transmitting the indication information to the first network function comprises:
in a procedure of PDU set based QoS handling, transmitting the indication information for packet discarding to the first network function.

6. The method according to claim 1, wherein
the indication information is carried in a header of an uplink data packet, or
the indication information is carried in a created uplink data packet.

7. (canceled)

8. The method according to claim 1, wherein the first network function comprises a User Plane Function (UPF).

9. A packet discarding processing method, performed by a first network function, comprising:
receiving indication information transmitted by an access network node, and
wherein the indication information is configured to indicate at least one of:
information of a Packet Data Unit (PDU) set based Quality of Service (QoS) handling packets discarding event; or
information of a PDU set based QoS handling packets discarding indication.

10. The method according to claim 9, wherein,
wherein the information of the packets discarding event indicates a triggering condition for conditional discarding,
wherein the information of the PDU set based QoS handling packets discarding indication indicates whether conditional discarding is needed to be performed or whether conditional discarding is allowed to be performed, and
wherein the triggering condition comprises at least one of:
a degree of network congestion being greater than a degree threshold,
a packet error rate being greater than a packet error rate threshold,
a packet delay budget being greater than a packet delay budget threshold,
a terminal status being in a predetermined status,
matching a packet discarding filter for data flows,
matching a packet discarding filter for data packet sets, or
matching a packet discarding filter for data packets.

11-12. (canceled)

13. The method according to claim 9, further comprising:
transmitting the indication information to a third network function or a fourth network function; and
receiving packet discarding policy information determined by the third network function or the fourth network function based on the indication information, wherein the packet discarding policy information is configured for performing packet discarding.

14. The method according to claim 9, wherein receiving the indication information transmitted by the access network node comprises:
in a procedure of PDU set based QoS handling, receiving the indication information for packet discarding transmitted by the access network node.

15. (canceled)

16. The method according to claim 9, further comprising:
transmitting notification information to a second network function; or
when an application function (AF) subscribes to notification information, transmitting the notification information to the AF via a second network function,
wherein the notification information comprises at least one of:
information of a measured report;
the information of the packets discarding event; or
the information of the packets discarding indication, and
wherein the second network function comprises a Network Exposure Function (NEF).

17. (canceled)

18. The method according claim 9, further comprising:
receiving configuration information transmitted by a fourth network function, wherein the configuration information indicates that the first network function performs packet discarding on at least one of a data flow, a data unit set, or a data packet.

19. (canceled)

20. The method according to claim 18, further comprising:
performing the packet discarding based on at least one of PDU set parameters or packet discarding policy information, and
wherein performing the packet discarding based on at least one of the PDU set parameters or the packet discarding policy information comprises at least one of:
when PDU Set Delay Budget (PSDB) is exceeded, performing packet discarding on a PDU set;
when PDU Set Error Rate is exceeded, performing packet discarding on a PDU set;
in response to delivery failure of a dependent PDU Set, performing packet discarding on a PDU set;
in response to delivery failure of an important PDU Set, performing packet discarding on a PDU set;
when PDU Set Error Rate is exceeded, performing packet discarding on packets of a PDU set;
in response to delivery failure of a dependent Packet in a PDU set, performing packet discarding on packets of a PDU set;
in response to delivery failure of an important Packet in a PDU set, performing packet discarding on packets of a PDU set; or
when PDU Set Delay Budget (PSDB) is exceeded, performing packet discarding on packets of a PDU set.

21. (canceled)

22. The method according to claim 9, wherein the first network function comprises a User Plane Function (UPF).

23-26. (canceled)

27. A packet discarding processing method, performed by a third network function, comprising:
receiving notification information transmitted by a User Data Report (UDR), and
wherein the notification information comprises at least one of:
information of a measured report;
information of a packets discarding event, wherein the information of the packets discarding event indicates a triggering condition for conditional discarding; or
information of a packets discarding indication, wherein the information of the packets discarding indication indicates whether conditional discarding is needed to be performed or whether conditional discarding is allowed to be performed
wherein the triggering condition comprises at least one of:
a degree of network congestion being greater than a degree threshold,
a packet error rate being greater than a packet error rate threshold,
a packet delay budget being greater than a packet delay budget threshold,
a terminal status being in a predetermined status,
matching a packet discarding filter for data flows,
matching a packet discarding filter for data packet sets, or
matching a packet discarding filter for data packets.

28. (canceled)

29. The method according to claim 27, further comprising:
subscribing to the notification information; and
based on the notification information, determining whether to perform packet discarding on data flows of a Packet Data Unit (PDU) Set based Quality of Service (QoS) handling.

30. (canceled)

31. The method according to claim 29, further comprising:
in response to determining to perform the packet discarding on the data flows of PDU Set based QoS handling, transmitting authorization information to a fourth network function;
wherein the authorization information is configured to indicate performing of packet discarding on at least one of a data flow, a data unit set, or a data packet,
wherein the fourth network function comprises SMF, and
wherein transmitting the authorization information to the fourth network function comprises:
in a PDU session modification procedure, transmitting the authorization information to the fourth network function.

32-33. (canceled)

34. The method according to claim 27, further comprising:
receiving indication information transmitted by a first network function, wherein the indication information is configured to indicate at least one of: information of a Packet Data Unit (PDU) set based Quality of Service (QoS) handling packets discarding event, or information of a PDU set based QoS handling packets discarding indication;
determining packet discarding policy information based on the indication information, wherein the packet discarding policy information is configured for performing packet discarding; and
transmitting the packet discarding policy information to the first network function,
wherein the first network function comprises a User Plane Function (UPF), and
wherein the third network function comprises a Policy Control Function (PCF).

35-47. (canceled)

48. A communication device, comprising:
an antenna;
one or more memories; and
one or more processors connected to the antenna and the one or more memories, wherein the one or more processors are configured to, by executing computer executable instructions stored on the one or more memories, control transmission and reception of the antenna, implement the method according to claim 1.

49. (canceled)
